(19) United States
(12) Patent Application Publication
(10) Pub. No.: US 2024/0278194 A1
(43) Pub. Date: Aug. 22, 2024

(54) PHENOLIC-GRAPHENE OXIDE COMPOSITIONS

(71) Applicant: Monash University, Clayton, Victoria (AU)

(72) Inventors: Mainak MAJUMDER, Clayton (AU); Abozar AKBARIVAKILABADI, Clayton (AU); Sally EL MERAGAWI, Clayton (AU); Petar JOVANOVIC, Clayton (AU)

(73) Assignee: Monash University, Clayton, Victoria (AU)

(21) Appl. No.: 18/569,729

(22) PCT Filed: Jun. 15, 2022
(86) PCT No.: PCT/AU2022/050592

§ 371 Date: Dec. 13, 2023

(30) Foreign Application Priority Data
Jun. 15, 2021 (AU) 2021901788

(51) Int. Cl. B01D 71/06; B01D 61/02; B01D 67/00; B01D 69/02; C02F 1/44

(52) U.S. Cl. CPC B01D 71/06; B01D 61/027; B01D 67/0079; B01D 69/02; C02F 1/442; B01D 2323/345; B01D 2325/04; B01D 2325/20

(57) ABSTRACT

Disclosed herein is a phenolic-graphene oxide composition comprising phenolic-graphene oxide having a carbon to oxygen (C:O) ratio of 2.1 or greater and 5 or less.

### FIELD

The invention relates to phenolic-graphene oxide compositions and related methods for the preparation thereof, and membranes comprising phenolic-graphene oxide and related methods for the preparation thereof.

### BACKGROUND

The use of graphene in separation devices is often considered in the context of idyllic single layers of impermeable graphene. The control of sub-nanometre perforations has popularised its potential as an atomically thin and molecularly selective sieve, inducing an unparalleled enthusiasm for research into the use and fabrication of graphene in ion transport, gas separation and water purification devices. However, there are significant difficulties in fabricating such graphene particularly on large commercial scales. Given this, research has tended to focus on the molecular gating properties of stacked, lamellar structured graphene oxide (GO) membranes. This lamellar structure is accompanied by the forfeiture of the atomic width of the quintessential graphene membrane. However, the tortuosity and elongated path length formed by the nanochannels between adjacent GO sheets of a laminar membrane is partially responsible for loss in permeance. The distribution of high friction, oxidised domains and the low transport mobility of water molecules confined in these regions by hydrogen bonding interactions with the highly hydrophilic functional groups of the GO nanocapillaries also contribute to significantly reducing the water permeance ceiling. Factors such as these are further exacerbated by a rise in membrane thickness. The hydrophilic characteristic of the GO sheets adversely influences the cohesion of two adjacent nanosheets in an aqueous environment, eliciting the structural instability and deterioration of membrane performance. Much of the instability in graphene oxide membranes stems from the presence of abundant hydrophilic oxygen groups. As water molecules spontaneously intercalate between GO sheets, they preferentially accumulate around the hydrophilic functional groups promoting enlargement of the capillary space to the point where distance surmounts the van der Waals attractive forces between adjacent nanosheets, causing the delamination of the thin-film membrane. Thus, the presence of the abundant oxygen functionalities is a major contributor to poor performance of GO laminar membranes.

Various methods of reduction have been used to deoxygenate GO sheets. Without these hydrophilic functionalities to act as spacers and facilitate the expansion of the nanochannel gallery, reduced GO membranes are notably more stable in polar environments. While beneficial for membranes, it is to the detriment of the solution-based approach central to large scale processing and fabrication. A notable reductant is hydrazine which efficiently restores the conjugated sp² structure associated with the intrinsic charge mobility ideal for use in energy storage devices. Owing to reduced water clustering around functional groups and increased hydrophobic character, the attained highly deoxygenated GO precipitates as irreversible agglomerates. In a comparable category are reductants such as hydroiodic acid. The use of these reductants requires the addition of a stabilising agent (polymers or surfactants) to allow for the formation of aqueous dispersion. Some of these chemicals are toxic in nature, which may make the membranes unsuitable for use in pharmaceutical, drinking water or food processing applications.

Previously published studies on the effect of reduction on the water permeance of GO membrane have not been consistent. Several studies emphasised more positive outcomes of reduction, wherein restoration of hydrophobic domains is associated with an increase in water permeance attributed to the elimination of water-clustering effects. However, some of these studies reported an associated decline in selectivity.

Furthermore, a number of studies have presented evidence that reduced GO membranes exhibit poor water permeability. This has been attributed to the loss of hydrophilic groups at the nanochannel inlet, preventing fast entry to the low friction channel.

It is an object of the invention to address at least one shortcoming of the prior art and/or provide a useful alternative.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF INVENTION

In a first aspect of the invention, there is provided a phenolic-graphene oxide composition comprising phenolic-graphene oxide having a carbon to oxygen (C:O) ratio of 2.1 or greater and 5 or less.

In a second aspect of the invention, there is provided a liquid crystalline phenolic-graphene oxide composition comprising discotic phenolic-graphene oxide particles having a carbon to oxygen (C:O) ratio of 2.1 or greater and 5 or less.

In an embodiment of the first or second aspects, the phenolic-graphene oxide comprises graphene oxide with a phenolic compound bonded thereto. By bonded, it is meant that the phenolic compound is physisorbed or chemisorbed thereto Suitable phenolic compounds comprise plant phenolic compounds. A non-limiting disclosure of plant phenolic compounds comprises phenolic acids, flavonoids, tannins, coumarins, lignans, quinones, stilbens, curcuminoids, and polyphenols. Preferably the phenolic compound comprises one or more catechol moieties.

In one form of the above embodiment, the phenolic compound has a planar structure (in particular a planar anthracene structure) or a substantially 2D structure. Preferably, the phenolic compounds are selected from the group consisting of: caffeic acid, gallic acid, quercetin, ellagic acid, coumarin, p-coumaric acid, and luteolin.

In one form of the above embodiment, the phenolic compound is from an olive extract, a grape extract, or is tannic acid. Preferably, the phenolic compound comprises, consists essentially of, or consists of one or more compounds, selected from the group consisting of: vanillic acid, phloretic acid, tyrosol, caffeic acid, and/or oleuropein.

In one form of the above embodiment, the phenolic compound has a molecular mass of at least 100 Da. Preferably, the molecular mass is at least 200 Da. More preferably the molecular mass is at least 300 Da. Even more preferably, the molecular mass is at least 400 Da. Most preferably, the molecular mass is at least 500 Da. Additionally, or alternatively, the molecular mass is up to 4000 Da. Preferably, the molecular mass is up to 3000 Da. More preferably the molecular mass is up to 2500 Da. Most preferably, the molecular mass is up to 2000 Da.

In an embodiment of the first or second aspects, the C:O ratio is 2.15 or greater. Preferably, the C:O ratio is 2.20 or greater. More preferably, the C:O ratio is 2.25 or greater. Most preferably, the C:O ratio is 2:30 or greater.

In an embodiment of the first or second aspects, the C:O ratio is 4 or less. Preferably, the C:O ratio is 3.5 or less. More preferably, the C:O ratio and 3 or less. Most preferably, the C:O ratio is 2.5 or less.

In an embodiment of the first or second aspects, at least 12% of the O moieties in the phenolic-graphene oxide are in the form of carbonyl groups. Preferably, at least 13% of the O moieties in the phenolic-graphene oxide are in the form of carbonyl groups. Most preferably, at least 14% of the O moieties in the phenolic-graphene oxide are in the form of carbonyl groups. Alternatively, or additionally, up to 70% of the O moieties in the phenolic-graphene oxide are in the form of carbonyl groups. More preferably, up to 65% of the O moieties in the phenolic-graphene oxide are in the form of carbonyl groups.

In an embodiment of the first or second aspects, the phenolic graphene oxide has a phenolic to graphene oxide weight ratio of less than 1. Preferably the weight ratio is 0.95 or less. More preferably, the weight ratio is 0.90 or less. Even more preferably the ratio is weight 0.85 or less. Most preferably, the ratio is weight 0.80 or less.

In an embodiment, the liquid crystalline phenolic-graphene oxide composition is a colloidal liquid crystalline phenolic-graphene oxide composition.

In an embodiment, the composition is shear thinning.

In an embodiment, the liquid crystalline phenolic-graphene oxide composition is in the nematic phase.

In an embodiment, the composition has a zero-shear viscosity of 100 Pa·s or less. Preferably, the zero-shear viscosity is 50 Pa·s or less. Most preferably, the zero-shear viscosity is 35 Pa·s or less.

In an embodiment, the composition has a contact surface angle on a PVDF support surface of less than 90 degrees. Preferably, the contact angle is 88 degrees or less. More preferably, the contact angle is 86 degrees or less. Most preferably, the contact angle is 85 degrees or less.

In an embodiment, the concentration of phenolic-graphene oxide particles is at least 5 g/L. Preferably, the concentration of the phenolic-graphene oxide particles is at least 6 g/L. More preferably, the concentration of the phenolic-graphene oxide particles is at least 7 g/L. Even more preferably, the concentration of the phenolic-graphene oxide particles is at least 8 g/L. Still more preferably, the concentration of the phenolic-graphene oxide particles is at least 9 g/L. Most preferably, the concentration of the phenolic-graphene oxide particles is at least 10 g/L.

In an embodiment, the phenolic-graphene oxide particles are platelets having a number average diameter in the range of from about 0.5 μm up to about 5 μm. Preferably, the average diameter is from about 1 μm. Preferably, the average diameter is up to about 4 μm.

In a third aspect of the invention, there is provided a method of forming a liquid crystalline phenolic-graphene oxide composition comprising:
providing a liquid phase reaction mixture comprising a phenolic compound and discotic graphene oxide particles; and
facilitating a reaction between the phenolic compound and the discotic graphene oxide particles for a time sufficient to form an composition comprising discotic phenolic-graphene oxide particles having a carbon to oxygen (C:O) ratio of greater than 2.1 and less than 5.

In an embodiment, the liquid phase reaction mixture comprises the phenolic compound and the discotic graphene oxide particles in a weight ratio of less than 1. Preferably the weight ratio is 0.95 or less. More preferably, the weight ratio is 0.90 or less. Even more preferably the weight ratio is 0.85 or less. Most preferably, the weight ratio is 0.80 or less.

In an embodiment, the liquid phase reaction mixture comprises the discotic graphene oxide particles in an amount of at least 5 g/L. Preferably, the concentration of the discotic graphene oxide particles is at least 6 g/L. More preferably, the concentration of the discotic graphene oxide particles is at least 7 g/L. Even more preferably, the concentration of the discotic graphene oxide particles is at least 8 g/L. Still more preferably, the concentration of the discotic graphene oxide particles is at least 9 g/L. Most preferably, the concentration of the discotic graphene oxide particles is at least 10 g/L.

In an embodiment, the step of facilitating the reaction comprises heating the liquid phase reaction mixture to a temperature of 80° C. or less. Preferably 78° C. or less. More preferably, 76° C. or less. Even more preferably, 74° C. or less. Most preferably, 72° C. or less. Additionally, or alternative, the step of facilitating the reaction comprises heating the liquid phase reaction mixture to a temperature of at least 35° C. Preferably at least 45° C. More preferably, at least 55° C. Most preferably, at least 70° C. Additionally or alternatively, the step of facilitating the reaction comprises subjecting the liquid phase reaction mixture to UV light, preferably in the presence of hydrogen peroxide. The UV light can be provided as UVA, UVB, or UVC. In forms of the invention in which the UV light is UVA or UVB, it is preferred that the method further includes subsequently subjecting the liquid phase reaction mixture to UVC light.

In an alternative embodiment, the reaction is carried out at room temperature. In this embodiment, the step of facilitating the reaction comprises contacting the phenolic compound with the discotic graphene oxide particles for a time sufficient to form the composition comprising the discotic phenolic-graphene oxide particles.

In an embodiment, the time is from about 0.5 hours up to about 16 hours. Preferably, the time is up to about 4 hours. More preferably, the time is up to about 3 hours. Most preferably, the time is up to about 2.5 hours. Alternatively, or additionally, the time is from about 0.75 hours. Preferably, the time is from about 1 hour. More preferably, the time is from about 1.25 hours. Most preferably, the time is from about 1.5 hours.

In an embodiment, prior to and/or during the step of facilitating the reaction, the method further comprises shear mixing the liquid phase reaction mixture.

In a fourth aspect of the invention, there is provided a phenolic-graphene oxide film comprising a laminar arrangement of phenolic-graphene oxide having a C:O ratio of 2.1 or greater and 5 or less.

In an embodiment, the laminar arrangement comprises a plurality spaced apart layers of phenolic-graphene oxide having an interlayer spacing therebetween graphene oxide sheets with a phenolic compound located or intercalated within the interlayer spacing.

In an embodiment, the interlayer spacing is 7.4 Å or greater when measured in a dry state. Preferably, the interlayer spacing is 7.6 Å or greater. More preferably, the interlayer spacing is 7.8 Å or greater. Most preferably, the interlayer spacing is 8.0 Å or greater.

In an embodiment, the interlayer spacing is 12 Å or less when measured in a wet state. Preferably, the interlayer spacing is 11.5 Å or less. More preferably, the interlayer spacing is 11 Å or less. Even more preferably, the interlayer spacing is 10.5 Å or less. Most preferably, the interlayer spacing is 10.3 Å or less.

In an alternate embodiment, such as when the phenolic compound has a planar structure (in particular a planar anthracene structure) or a substantially 2D structure, the film has an interlayer spacing of from about 6.5 up to about 7.4 Å when measured in a dry state.

In a fifth aspect of the invention there is provided a separation membrane comprising a membrane layer formed from a phenolic-graphene oxide film of the third aspect of the invention and/or embodiments and/or forms thereof.

In an embodiment, the separation membrane comprises a substrate layer with the membrane layer applied thereto, and the membrane layer has a thickness of 100 nm or less. Preferably the thickness is 80 nm or less. More preferably the thickness is 60 nm or less. Even more preferably the thickness is 40 nm or less. Most preferably the thickness is 35 nm or less.

In an embodiment, the membrane has a water permeance of 20 L·m⁻²·h⁻¹·bar⁻¹ or greater. Preferably the water permeance is 30 L·m⁻²·h⁻¹·bar⁻¹ or greater. More preferably, the water permeance is 40 L·m⁻²·h⁻¹·bar⁻¹ or greater. Most preferably the water permeance is 50 L·m⁻²·h⁻¹·bar⁻¹ or greater.

In an embodiment, the separation membrane has a retention of at least 90% for molecules with a hydrated radius of 6 Å or greater.

In an alternate embodiment, such as when the phenolic compound has a planar structure (in particular a planar anthracene structure) or a substantially 2D structure, the separation membrane has an interlayer spacing of from about 6.5 up to about 7.4 Å.

In preferred forms of the above embodiment, the separation membrane is a low permeance high selectivity membrane. In one or more forms, the permeance is 5 L·m⁻²·h⁻¹·bar⁻¹ or less. Preferably 3 L·m⁻²·h⁻¹·bar⁻¹ or less. Most 1 L·m⁻²·h⁻¹·bar⁻¹ or less. In one or more forms, the separation membrane has a retention of at least 90% for molecules with a hydrated radius of 0.33 nm or greater.

In a sixth aspect of the invention, there is provided a method of forming a phenolic-graphene oxide membrane comprising solution casting a liquid crystalline phenolic-graphene oxide composition of the second aspect of the invention and/or embodiments and/or forms thereof onto a surface to form the phenolic-graphene oxide membrane.

In an embodiment, the step of solution casting further comprises subjecting the liquid crystalline phenolic-graphene oxide composition to shear forces sufficient to shear align the discotic phenolics-graphene oxide particles.

In a seventh aspect of the invention, there is provided a method of forming a phenolic-graphene oxide membrane comprising:
contacting a graphene oxide film or membrane with a phenolic compound, and
facilitating a reaction between the phenolic compound and the graphene oxide for a time sufficient to form a phenol-graphene oxide film or membrane in which the phenolic-graphene oxide has a carbon to oxygen (C:O) ratio of greater than 2.1 and less than 5.

In an embodiment, the step of facilitating the reaction comprises heating the liquid phase reaction mixture to a temperature of 80° C. or less. Preferably 78° C. or less. More preferably, 76° C. or less. Even more preferably, 74° C. or less. Most preferably, 72° C. or less. Additionally, or alternative, the step of facilitating the reaction comprises heating the liquid phase reaction mixture to a temperature of at least 35° C. Preferably at least 45° C. More preferably, at least 55° C. Most preferably, at least 70° C.

In an alternative embodiment, the reaction is carried out at room temperature. In this embodiment, the step of facilitating the reaction comprises contacting the phenolic compound with the discotic graphene oxide particles for a time sufficient to form the composition comprising the discotic phenolic-graphene oxide particles.

In an embodiment, the time is from about 0.5 hours up to about 16 hours. Preferably, the time is up to about 4 hours. More preferably, the time up to about 3 hours. Most preferably, the time is up to about 2.5 hours. Preferably, the time is from about 0.75 hours. More preferably, the time is from about 1 hour. Even more preferably, the time is from about 1.25 hours. Most preferably, the time is from about 1.5 hours.

In embodiments of the third, fourth, fifth, sixth, or seventh aspects of the invention, the phenolic-graphene oxide comprises graphene oxide with a phenolic compound bonded thereto. Suitable phenolic compounds comprise plant phenolic compounds. A non-limiting disclosure of plant phenolic compounds comprises phenolic acids, flavonoids, tannins, coumarins, lignans, quinones, stilbens, curcuminoids, and polyphenols. Preferably the phenolic compound comprises one or more catechol moieties.

In embodiments of the third, fourth, fifth, sixth, or seventh aspects of the invention, the phenolic compound has a planar structure (in particular a planar anthracene structure) or a substantially 2D structure. Preferably, the phenolic compounds are selected from the group consisting of: caffeic acid, gallic acid, quercetin, ellagic acid, coumarin, p-coumaric acid, and luteolin.

In embodiments of the third, fourth, fifth, sixth, or seventh aspects of the invention, the phenolic compound is from an olive extract, a grape extract, or is tannic acid. Preferably, the phenolic compound comprises, consists essentially of, or consists of one or more compounds, selected from the group consisting of: vanillic acid, phloretic acid, tyrosol, caffeic acid, and/or oleuropein.

In one form of the above embodiments, the phenolic compound has a molecular mass of at least 100 Da. Preferably, the molecular mass is at least 200 Da. More preferably the molecular mass is at least 300 Da. Even more preferably the molecular mass is at least 400 Da. Most preferably, the molecular mass is at least 500 Da. Additionally, or alternatively, the molecular mass is up to 4000 Da. Preferably, the molecular mass is up to 3000 Da. More preferably the molecular mass is up to 2500 Da. Most preferably, the molecular mass is up to 2000 Da.

In embodiments of the third, fourth, fifth, sixth, or seventh aspects of the invention, the C:O ratio is 2.15 or greater. Preferably, the C:O ratio is 2.20 or greater. More preferably, the C:O ratio is 2.25 or greater. Most preferably, the C:O ratio is 2:30 or greater.

In embodiments of the third, fourth, fifth, sixth, or seventh aspects of the invention, the C:O ratio is 4 or less. Preferably, the C:O ratio is 3.5 or less. More preferably, the C:O ratio and 3 or less. Most preferably, the C:O ratio is 2.5 or less.

In an embodiment of the third, fourth, fifth, sixth, or seventh aspects of the invention, at least 12% of the O moieties in the phenolic-graphene oxide are in the form of carbonyl groups. Preferably, at least 13% of the O moieties in the phenolic-graphene oxide are in the form of carbonyl groups. Most preferably, at least 14% of the O moieties in the phenolic-graphene oxide are in the form of carbonyl groups. Alternatively, or additionally, up to 70% of the O moieties in the phenolic-graphene oxide are in the form of carbonyl groups. More preferably, up to 65% of the O moieties in the phenolic-graphene oxide are in the form of carbonyl groups.

In an eighth aspect of the invention, there is provided a use of a phenolic-graphene oxide film of the fourth aspect and/or embodiments and/or forms thereof or the separation membrane of the fifth aspect and/or embodiments and/or forms thereof in a membrane separation process.

In an embodiment, the membrane separation process is a water separation process that comprises separation of a compound having a molecular mass of at least 479 Da from water. Preferably the compound is selected from the group consisting of a dye or natural organic matter such as perfluoroalkyl compounds.

In an embodiment, the use is in a wastewater treatment process.

In an embodiment, the use is for a nanofiltration process.

In an embodiment, the use is for a high selectivity low permeance process.

In a ninth aspect of the invention, there is provided a phenolic-graphene oxide film of the fourth aspect and/or embodiments and/or forms thereof or a separation membrane of the fifth aspect and/or embodiments and/or forms thereof when used in a membrane separation process.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF DRAWINGS

FIG. 1: Flow diagram illustrating formulation of olive extract reduced polyphenol-GO suspension (ZERS) and a photograph of the subsequent membrane fabricated by gravure printing.

FIG. 2: Graphs showing (a) UV-vis spectra of polyphenol-GO aqueous dispersion, (b) FTIR spectra, and (c) XPS survey scan before (GO) and after (polyphenol-GO) being reduced via olive extract at 70° C. for 30, 60, 90, 120, 150 and 960 min (=16 h).

FIG. 3: (a) FTIR and (b) UV-vis spectra of ZERS dispersions after reduction at 20, 35, 45 and 70° C. for 120 min compared to unreduced GO (green) and (c) colloidal stability of GO and ZERS Suspension 3 months post-reduction.

FIG. 4: (a) Atomic % and ratio of carbon and oxygen and (b) intensity of FTIR peaks present in reduced GO normalised to the intensity of peaks in GO as a function of reduction time.

FIG. 5: Raman spectra scan before (GO) and after being reduced via olive extract at 70° C. for 30, 60, 90, 120, 150 and 960 min (=16 h).

FIG. 6: Deconvoluted C 1s spectra for (a) GO, (b) 90 min, and (c) 16 h of olive reduction and deconvoluted O 1s spectra for (d) GO, (e) 90 min, and (f) 16 h of olive extract reduction.

FIG. 7: Schematic illustrating proposed reaction mechanisms involved in the reduction of (a) epoxy groups, (b) hydroxyl groups, and (c) carbonyl groups by olive polyphenolic extract.

FIG. 8: Flow properties and phase behaviour of GO and ZERS dispersions. (a) graph illustrating steady-state shear measurement and zero-shear viscosity (inset), pseudocolor polarized light micrographs of (b) GO and (c) ZERS (containing 10 mg/mL GO and 1 mg/ml polyphenol) dispersions.

FIG. 9: Top surface SEM micrograph of PVDF supported ZERS membrane (scale bar is 10 micron).

FIG. 10: Effect of polyphenol (PP) concentration on wettability of a 10 mg/mL GO suspension on the MDI PVDF support. (a) Contact angle measurement of the suspension droplet by varying the PP concentration where (i) GO, (ii) GO with 1 mg/mL PP. (iii) GO with 2 mg/mL PP. (iv) GO with 4 mg/mL PP, and (v) GO with 8 mg/mL PP depict a trend of decreasing contact angle with increasing polyphenol content. (b) Surface tension of GO-polyphenol suspension wherein an increase in the polyphenol content is linked to a decrease in surface tension of the suspension.

FIG. 11: Permeance and retention behaviour of GO, ZERS and ZERM membranes. (a) Cross sectional SEM micrograph of PVDF supported ZERS membrane with thickness of approximately 34 nm (scale bar is 400 nm). (b) Water permeance (lower two trend lines) and TA retention (upper two trend lines) of ZERS (filled bullets) and ZERM (empty bullets) membranes with optimal perm-selective properties observed at 90 mins of reduction for ZERS and 120 mins for ZERM. (c) Water flux versus applied transmembrane pressure for optimal ZERS (circle), optimal ZERM (diamond), and GO (square). (d) Retention performance as a function of hydrated radius for probe molecules with different charges and sizes for optimal ZERS (circle), optimal ZERM (diamond), and GO (square). The symbols with a horizontal dash (e) represent negatively charged probes, the symbols with an internal cross (@) represent positively charged probes, and empty symbols (O) represent neutrally charged probes.

FIG. 12: Feed, permeate, and retentate stream retention details for (a) ZERS and (b) ZERM retention of TA as a function of reduction time in olive extract where 0 min of reduction refers to as prepared unmodified GO membranes. Feed, permeate, and retentate stream retention details for (c) ZERS, (d) ZERM, and (e) GO retention details of dye probes.

FIG. 13: XRD peaks of (a) ZERS in the dry state and (b) ZERS membranes in the wet state and (c) the interlayer distance variance with increasing reduction time for ZERS in the dry state (squares) and the wet state (circles).

FIG. 14: Schematic representation of the nanochannels of (a) a dry GO membrane with interlayer spacing of 7.2 Å, (b) a dry GO membrane with an interlayer spacing of 8.1 Å, (c) a wet GO membrane with an expanded interlayer of 11.8 Å wherein water molecules cluster around the hydrophilic domains and have slow transport through the membrane, and (d) a polyphenol reduced GO membrane with a 10.1 Å interlayer distance with low friction flow and fast water transport.

FIG. 15: Graph showing long-term crossflow characterisation of optimal ZERS (70° C.—90 min) and unmodified GO membrane.

FIG. 16 is a graph illustrating permeance and TA retention performance of rGO-polyphenol and GO hollow fiber membranes.

FIG. 17 provides two photographs showing (i) the uncoated PES hollow fiber support (left) and (ii) the coated rGO-polyphenol hollow fiber nanofiltration membrane (right). The scale is in mm.

FIG. 18 is a scanning electron microscope images of GO coated HF with 100 mg/L rGO-polyphenol suspension. The scale bar represents 10 μm.

FIG. 19 is a scanning electron microscope images of GO coated HF with 5 mg/L rGO-polyphenol suspension. The scale bar represents 10 μm.

FIG. 20 is a graph showing the water flux of hGO-polyphenol membranes at 0.25 bar.

FIG. 21 is a graph showing retention for rose bengal (MW of 973 Da) and methyl orange (MW of 327 Da).

FIG. 22 is a graph showing the water permeance (open circle symbol) of membranes with optimal permeance for ion retention being 0.4 LMH/bar and Retention of 10 mM NaCl (solid square symbol) and Na₂SO₄ (open square symbol).

FIG. 23 is a graph showing the retention of rGO-caffeic acid, rGO-gallic acid and rGO-quercetin membranes for 0.2M NaCl.

FIG. 24 is a graph showing interlayer spacing of rGO-caffeic acid indicating optimal reduction times for size exclusion-based retention of NaCl.

### DESCRIPTION OF EMBODIMENTS

The invention relates to a phenolic-graphene oxide composition having a carbon to oxygen (C:O) ratio of 2.1 or greater and 5 or less. The inventors have found that such a composition is particularly useful in liquid crystalline form for the preparation of separation membranes via a shear casting process.

The use of plant derived phenolic compounds is particularly advantageous since these reduce graphene oxide under mild reduction reaction rates which permits process control over both the rate of reduction and degree of reduction, thus allowing the process to be tuned.

Still further, the use of phenolic compounds in a weight ratio of less than 1 relative to the amount of graphene oxide has surprisingly been found to provide a lower zero-point shear rate than in comparison with the same graphene oxide solution without phenolic treatment. This lower zero-point shear rate makes it easier to produce high quality films of lower thickness than in comparison with graphene oxide solutions. The resulting membranes can be manufactured substantially thinner than current graphene oxide membranes whilst maintaining high water permeability and high retention for impurities.

The inventors have also found that graphene oxide separation membranes may be treated with a phenolic compound under reaction conditions to intercalate the phenolic compounds between graphene oxide layers within the membrane and thus form a membrane having a C:O ratio of 2.1 or greater and 5 or less.

The invention will be described in more detail below in relation to one or more preferred embodiments thereof.

### Example 1

### Materials and Methods

### Membrane Preparation

The graphene oxide (GO) utilised in this study was sourced from the Sixth Element Materials Technology Co. Ltd (Changzhou, China) and was formulated into a ˜10 g/L GO suspension with rheological properties consistent with the shear thinning behaviour as necessary to produce large area GO membranes. Discotic nematic phase GO has non-Newtonian flow which permits shear forces imposed by a doctor blade to be utilised to fabricate large-area films. It is supposed that the imposition of high shear stress orients the GO sheets to allow for a highly oriented film to be continuously and uniformly formed over a porous support. The size of a membrane produced via this shear alignment method is limited by the size of the printing machinery. The membranes fabricated for use in this work were printed using a gravure printer (Labratester, Norbert Schlafli Machinery Company, Switzerland) with a resulting membrane sheet size of 13×14 cm².

To fabricate these membranes, the 10 g/L GO suspension was uniformly distributed over printing plate by a doctor blade. The flat sheet polyvinylidene fluoride (PVDF) ultrafiltration membrane support was then pressed against the plate by the printer roller allowing the transfer of the GO suspension from the printing plate to the substrate (PVDF, HVF, 0.2 μm pore size sourced from MDI, India).

### Preparation of Olive Extract

Whole black olives (Olea europaea) were locally sourced, pitted and soaked in distilled water for several hours. 50 g of olive was measured and added to 200 mL of water and then blended. The suspension was warmed in the oven at 50° C. for 3 h and then left to sit for 24 h before it was filtered through a Grade 1 Whatman filter paper (with a pore size of 11 μm) to produce the olive extract. The olives and the extract were stored at 3° C. until used. This extract has a solid content of 5.8 mg/mL and a pH of 3.5.

### Preparation of Polyphenol-Graphene Oxide

To illustrate the effect of the inclusion of polyphenol on the perm-selective properties of a GO membranes, two methods for preparing polyphenol-GO membranes were used.

The first method involved a solution-based reduction of a polyphenol-GO suspensions, designated herein as ZERS (Zaytoun Extract Reduced Suspension). 25 mL of the prepared olive extract was combined with 25 mL of a ˜20 g/L GO suspension and then sheared at 3000 rpm. for 5 min resulting in a 10 g/L GO with ˜3 mg/mL polyphenol content (3:1 GO to polyphenol ratio). The polyphenol-GO suspensions were then treated at 70° C. for periods of time ranging from 0.5 to 16 h. From these suspensions ZERS membranes were fabricated according to the gravure printing technique.

The second approach considered the reduction of a prefabricated GO membrane, designated herein as ZERM (Zaytoun Extract Reduced Membranes). Samples of GO membranes were placed in 25 mL of extract and then reduced at 70° C. for 0.5 to 16 h. These membranes were rinsed with DI water following treatment.

From all ZERS and ZERM membranes prepared at different stages of reduction, the optimal membrane from each category was selected on the basis of maximal water permeance. The water permeance of these membranes were further characterised across pressures ranging from 0.5 to 5.0 bar. Dye molecules were used as molecular probes to characterise the selectivity of the GO nanofiltration membranes due to the simplicity of their detection, good solubility in aqueous media, and broad range of chemistries. The selectivity of GO, and the optimal ZERS and ZERM membranes were evaluated with an array of probes with different chemistries.

### Material Characterisation

### Free-Standing Film for Material Characterisation

Freestanding GO films were prepared from a 10 g/L GO suspension cast onto a glass substrate and dried at 40° C. for 24 hours. The dried film was then mechanically removed from the glass support by a razor blade to form a thick freestanding film.

### Attenuated Total Reflectance-Fourier Transform Infrared Spectroscopy (FTIR)

FTIR characterisation was conducted using a Perkin Elmer Spectrum 100. Spectra were recorded over a 4-scan average at wavenumbers from 4000 to 400 cm⁻¹ with a resolution of 4 cm⁻¹ and used to analyse the chemical structure of the GO films vis-a-vis the occurrence and intensity of peaks unique to specific functional groups.

### X-Ray Diffraction (XRD)

For characterisation of dry GO films, as-prepared freestanding films were cut into approximately 1 cm² squares and mounted on a sample holder and installed in a Rigaku Miniflex 600 diffractometer. The diffractometer was operated at 40 kV and 15 mA with Cu-Kα1 radiation at a scan rate of 5 deg/min and a step size of 0.02. For the wet-state characterisation of the GO films, 1 cm² segments of films were submerged in DI water for 2 hours prior to XRD characterisation. The background of these holders was also recorded and subsequently subtracted from the XRD spectra of the dry films. The size of the GO nanochannels (i.e. d-spacing) was calculated using the Bragg's law, i.e. λ=2d sin θ where λ is the x-ray wavelength (1.54 Å), d is the interlayer spacing between adjacent GO sheets, and θ is the diffraction angle.

### X-Ray Photoelectron Spectroscopy (XPS)

Compositional analysis of the GO was determined using x-ray photoelectron spectroscopy (XPS, Thermo Fisher, Nexsa Surface Analysis System) where both survey scans and C 1s and O 1s were recorded using Al Kα radiation source, O 1s and C 1s were collected at a pass energy of 50 eV while survey scans were collected at 150 eV. O 1s and C 1s peaks were deconvoluted through a multi-peak Gaussian fit paired with a Shirley background correction.

### Scanning Electron Microscopy (SEM)

Scanning electron microscopy (SEM) were used to obtain high-resolution information on the surface and cross-sectional morphology of GO films. As GO is relatively insulating, all samples were sputter-coated with a ˜ 2 nm carbon conductive coating in a Cressington 208 HR before imaging. All SEM micrographs were obtained using a FEI Magellan 400 Field Emission Microscope operating at 3.0 keV and 6 pA. Cross section membrane samples were freeze fractured by submersion in liquid nitrogen for 1 min, shattered by tweezers, and then mounted on pre-tilt sample holders secured by carbon tape.

### Ultraviolet-Visible (Uv-Vis) Spectroscopy

A Perkin Elmer Lambda 365 UV-Vis spectrometer was used to measure the progress of GO reduction. For this purpose, the GO characteristic peak at 230 nm was monitored in adsorption spectra collected at wavelengths from 200 to 700 nm.

### Raman Spectroscopy

Raman spectroscopy was performed to characterise structural changes during reduction. The Raman spectra of GO has two characteristic peaks. The peak present at ˜1330 cm⁻¹, known as the D-band corresponds to the presence of structural defects within the plane of the GO nanosheet. The G-band, present at ˜1580 cm⁻¹, is correlated to the in-plane stretching of sp² hybridised carbons. Raman spectra were generated using a Renishaw VIS Raman Spectrometer equipped with a HeNe (633 nm) laser operating at 10% power. Extended scans (10 s) were performed at wavenumbers between 200 and 3200. Peak fitting was carried out using the GRAMS/AI software package and the fitted curves were used to determine the I_{D}/I_{G} ratios.

### Rheological Characterization

Rheological tests were performed using a strain-controlled ARES G2 rheometer (TA instruments, USA). A cone and plate geometry with a diameter of 50 mm and cone angle 2° was used. The measurements were carried out at a constant gap of 0.045 mm and temperature of 23.00±0.01° C. was maintained. Initially, steady-state tests were performed by measuring viscosity as a function of shear rate ranging from 0.01 to 100 s⁻¹. Dynamic strain sweep was performed at an angular frequency of 10 rad/s to identify the linear viscoelastic regime (LVR). Dynamic frequency sweep was carried out over the range of 0.1 to 100 rad/s at a constant strain within the LVR.

### Nanofiltration Characterisation

The retention and permeance of probe molecules were tested through dead-end and crossflow nanofiltration characterisation techniques to show the efficiency of a GO membrane sample. Organic probes with different chemistries were used including: Tannic Acid (TA, 1701 Da, negatively charged), Brilliant blue (BB, 793 Da, negatively charged), Methyl blue (MB, 799 Da, negatively charged), Rhodamine B (RB, 479 Da, negatively charged), Orange G (OG, 452 Da, negatively charged), Methylene Blue (MeB, 320 Da, positively charged), Methyl Orange (MO, 327 Da, negatively charged), and Methyl Red (269 Da, Neutral).

Dead-end filtration tests were conducted in dead-end filtration cells from Sterlitech (HP4750 Stirred Cell, Sterlitech, USA), on membrane samples with an effective surface area of 14.6 cm². Prior to recording of any perm-selective properties, the membranes underwent a water permeance stabilisation step wherein deionised (DI) water was permeated through the membrane for 2 hours at 1 bar. The pressure was maintained by pressurised air regulated by a Fluigent pressure pump (MFCS-EX Extended flow control, France). Following the stabilisation period, water permeance was measured. Mass readings were recorded each second using Radwag precision balances (PS1000.R2, Poland) with a customised Labview interface to continuously record permeance measurements. Membrane permeance, J. (L m⁻²h⁻¹bar⁻¹), or LMH/bar) is defined as: J=Vₚ/(A·P·t) where, Vₚ is the volume permeated in time, t, through a membrane with an effective surface area, A, at an applied pressure, P.

In order to evaluate the selectivity of specific probes, 100 mL of 30 mg/L probe feed solutions, prepared in DI water, was placed in the internal reservoir of the dead-end filtration cell. The retention of the probe was evaluated following a 75% water recovery. The contents of the cell were stirred continuously at 800 rpm for the duration of the test. The membrane retention, R (%), was determined using the following expression: R=(Cᵣ−Cₚ)/Cᵣ×100% where, Cᵣ is the concentration of the probe in the retentate stream and Cₚ is the concentration of the probe in the permeate.

In order to validate dead-end results and determine long-term stability of the polyphenol-GO membranes fabricated, bench-scale crossflow filtration was used. The crossflow testing apparatus is composed of a Sterlitech CF042 crossflow cell, pump, a stainless steel 20 L feed reservoir, and a temperature control system. The Sterlitech cell accommodates a membrane with an active area of 42 cm² (9.21×4.57 cm). The inclusion and adjustment of a bypass valve allowed for the control of the crossflow rate at 0.25 L/min and transmembrane of 0.5 bar. Permeate and retentate-streams were recirculated back to the feed reservoir to maintain a constant feed volume (10 L) and concentration (30 ppm of TA). The feed reservoir is maintained at a pH of 7 and is temperature controlled using a cooling coil connected to a cold water tap at 25° C. In crossflow filtration, due to the recirculation of the permeate and retentate streams, there is no measurable concentration of the feed, thus, rejection as defined relative to the feed concentration, C_{f}, as R=(C_{f}−Cₚ)/C_{f}×100%.

### Results and Discussion

### Characterisation of Reduced Polyphenol-GO

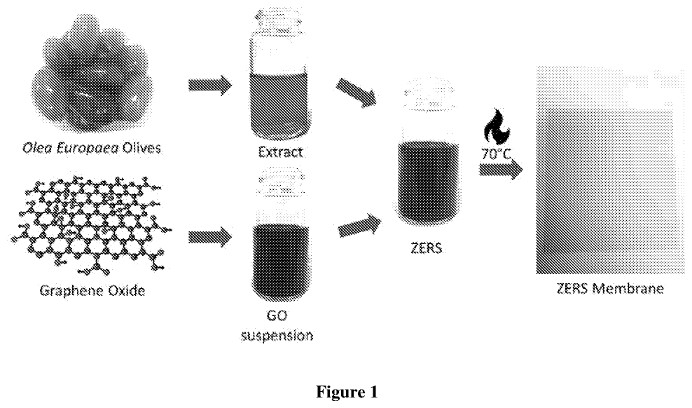

The method of preparation of GO and polyphenol composite dispersions is shown in FIG. 1. FIG. 1 shows the formulation of olive (zaytoun in Arabic) extract reduced polyphenol-GO suspension (ZERS) and a photograph of the subsequent membrane fabricated by gravure printing. The influence of olive extract in the reduction of GO was characterised through multiple techniques such as UV-vis, FTIR, and X-ray Photoelectron Spectroscopies to assess the reaction mechanisms.

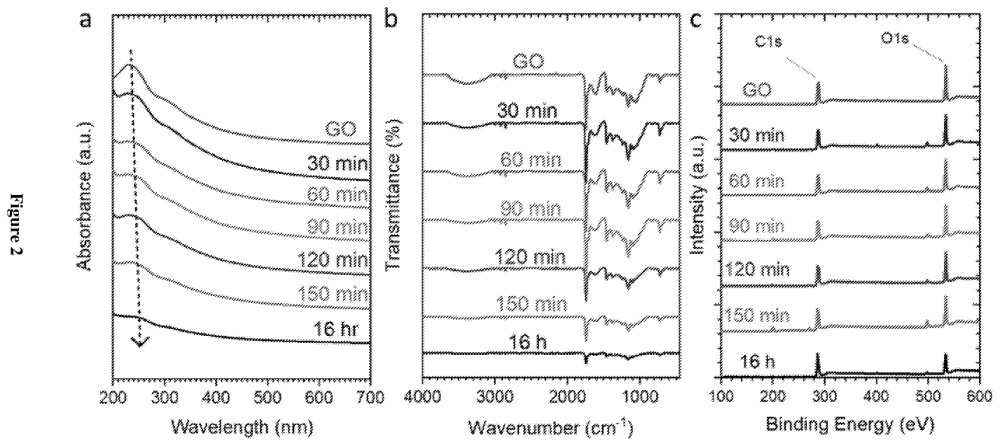

FIG. 2 shows (a) UV-vis spectra of polyphenol-GO aqueous dispersion, (b) FTIR spectra, and (c) XPS survey scan before (GO) and after (polyphenol-GO) being reduced via olive extract at 70° C. for 30, 60, 90, 120, 150 and 960 min (=16 h). GO, as shown in FIG. 2, has a UV-vis absorption peak at 230 nm that results from a π-π transition of aromatic C═C bonds with a slight shoulder at 300 nm derived from a n-π transition of C═O bonds. Over the course of the reaction, the intensity of the peaks decayed and red-shifted to 264 nm and disappeared after 16 h, and this is associated with the characteristic of rGO.

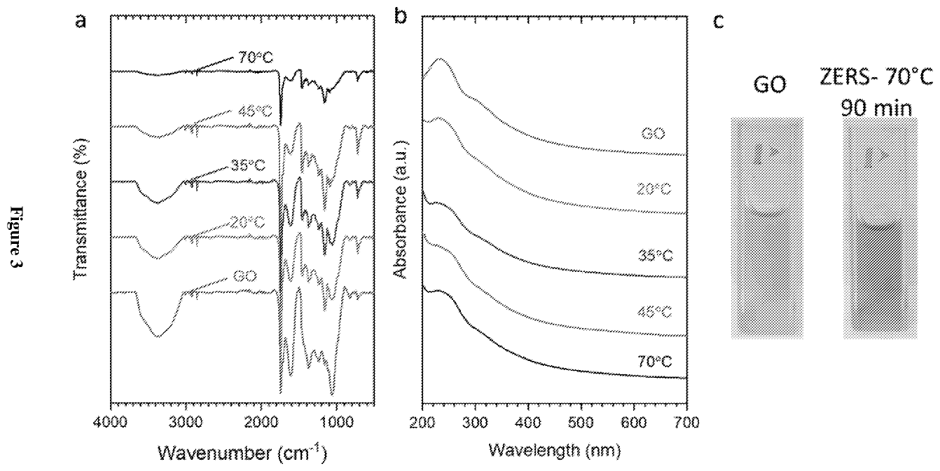

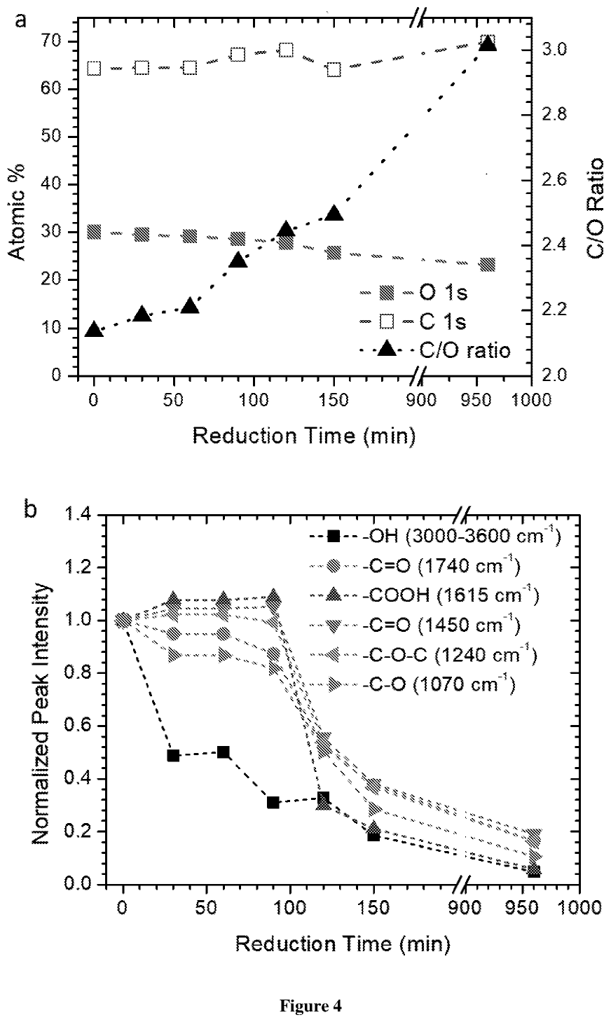

The influence of temperature on the reduction process was also investigated. FIG. 3 shows (a) FTIR and (b) UV-vis spectra of ZERS dispersions after reduction at 20, 35, 45 and 70° C. for 120 min compared to unreduced GO (green) and (c) colloidal stability of GO and ZERS Suspension 3 months post-reduction. From the results, at lower temperatures a weakened reducing effect was observed (FIG. 3b). Furthermore, the colloidal olive extract-reduced GO suspensions (ZERS) remained stable in water even up to three months following reduction (FIG. 3c) even in the absence of stabilising surfactants. Over the course of several hours of reduction, the intensities of peaks corresponding to GO's oxygen functionalities diminish dramatically. The intensity of peaks related to intercalated —OH diminishes immediately which is indicative of water molecules not being as confined within the GO sheets following minimal reduction. Following 16 h of reduction with olive extract, the intensities of the FT-IR peaks corresponding to the oxygen functionalities are minimal, with only the carbonyl stretching vibration peak at 1740 cm⁻¹ being present with any significant intensity. FIG. 4 shows (a) Atomic % and ratio of carbon and oxygen and (b) intensity of FTIR peaks present in reduced GO normalised to the intensity of peaks in GO as a function of reduction time. Interestingly, there is a sharp drop in the intensity of most peaks following 90 min of reduction (FIG. 4b), indicating a specific turning point between the mild reduction of GO using olive extract and a harsher reduction associated with negative implications for the permeance of the membrane.

FTIR peaks depicted in FIG. 2c have been assigned to specific functional groups; the broad peak from 3000 to 3600 cm⁻¹ represents the vibration and deformation of —OH groups either from alcohols on the GO or from intercalated water molecules. The intense peak at 1740 cm⁻¹ represents the stretching vibration of carbonyls (—C═O) typically associated with carboxylic acid (—COOH). The peak present at 1615 cm⁻¹ signifies the bending of free water bonds and may be attached to a smaller indistinguishable peak representing the in-plane stretching of sp²-hybridised carbon bonds (C═C), typically observed between ˜1500-1600 cm⁻¹.³⁰ At 1242 cm⁻¹, there is a peak representative of the ring stretching from epoxide (—O—) functional groups while the peak at 1070 cm⁻¹ is present due to the stretching of alkoxy groups. Finally, the peak at 720 cm⁻¹ is indicative of the bending of alcohol (—OH) groups.

There is a demonstrated increase in epoxy, carboxylic acid, and ketonic bonds in the first 90 minutes of the reaction observed in ZERS films by FTIR (FIG. 4b). Without wishing to be bound by theory, inventors are of the view that the increase in groups within the films suggests that the polyphenols are covalently bound to the reduced GO sheets. Polyphenols have also been shown to polymerise providing a mechanism for the cross-linking of GO sheets. Alternatively, these polyphenols contain benzene rings which may adsorb through π-π interaction with the aromatic rings of the graphene oxide.

XPS further validates the removal of these functional groups during the reaction. Elemental analysis of the XPS survey spectra in FIG. 2c depicts the trend of an increasing proportion of atomic carbon to oxygen detected in the reduced GO sheets as the ratio rises from 2.12 to 2.48 after 150 min and then increases further to 2.99 after 16 h (FIG. 4a). This establishes that the elimination of oxygenated groups from GO by olive extract has a tuneable dependency on reduction time. In comparison to commonly used reducing agents such as hydroiodic acid (HI), which increases the C/O ratio to ˜6 following brief (˜5 min) reduction, the gradual variation of the C/O ratio allows one to study the effect of varying the C/O ratio towards the low-end of the C/O ratio and the role it may play on achieving the optimal reduction conditions for enhanced perm-selective properties.

Analysis of the deconvoluted C1s XPS spectra of GO show peaks at 284.8 cV, 286.5 cV, and 288.6 eV which are representative of sp² hybridised carbon (C—C, C═C and C—H), —C—O and —C═O bonds, respectively. The olive-extract reduced GO exhibit the same carbon bond peaks; however, the fraction of carbon participating in C—O singles bonds reduces greatly and are seemingly the most influenced by the reduction process. Meanwhile, there is an intensification of the sp2 carbon peak, indicating the recovery of graphitic domains on the GO sheets.

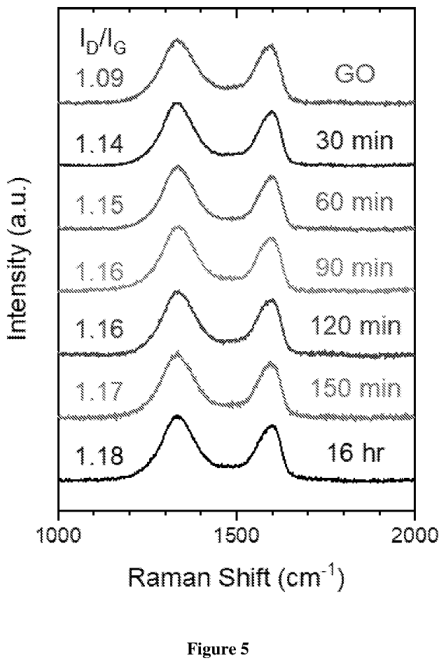

FIG. 5 shows a Raman spectra scan before (GO) and after being reduced via olive extract at 70° C. for 30, 60, 90, 120, 150 and 960 min (=16 h). The decrease of oxygen functional groups from GO sheets can be further observed using Raman spectroscopy and the relative intensities of the D and G peaks acquired at around 1330 cm⁻¹ and 1600 cm⁻¹, respectively. The D peak typically represents out of plane vibrations of sp² hybridised carbon domains caused by structural defects. Conversely, the G peak originates from in-plane vibrations. Thus, variance in the ratio of intensity between the D and G peaks can indicate a measure of the disorder and defects, and as such the recovery of sp² regions as a result of reduction. In a comparison of the relative intensities of the D and G peaks (I_{D}/I_{G}) of the GO membranes, Raman spectra reveals, as depicted in FIG. 5, with reduction, the ratio of D/G increased after 16 h, and as such an increase structural defects and vacancies are introduced to the GO sheets. This is in agreement with Raman spectrum of GO reduced by hydrazine and L-ascorbic acid.

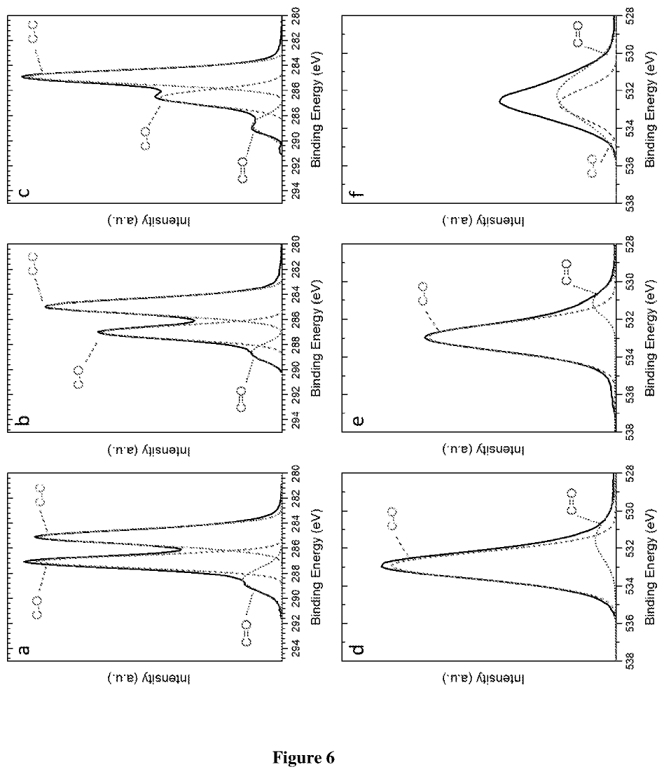

FIG. 6 shows deconvoluted C 1s spectra for (a) GO. (b) 90 min, and (c) 16 h of olive reduction and deconvoluted O 1s spectra for (d) GO, (c) 90 min, and (f) 16 h of olive extract reduction. The result implies that the sp²-hybridized graphene domains are more numerous but smaller than the domains present in unmodified GO. In the analysis of the deconvoluted O1s XPS spectra (FIG. 6d-f), there is a mirrored loss of oxygens participating in —C—O and —C═O bonds. Yet, it is the bonds representing epoxy and tertiary alcohols that are effectively reduced. The primary oxygen functionalities that remain following reduction are the carbonyls associated with carboxylic acid. The carbonyls of carboxylic acid groups are further stabilised by the availability of a donated electron pair from the adjacent oxygen atom. In comparison, ketone and aldehyde groups are more reactive; ketones are more stable compared to aldehydes due to the greater steric hindrance associated with the approach of the reactive species.

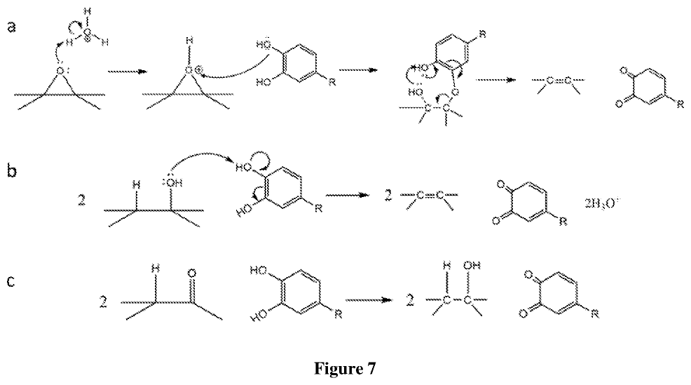

There are numerous phenolic antioxidants present in olives and possibly present in the resultant extract the major component of which is oleuropein and, although diverse, for the purpose of understanding the reaction may be simplified to catechol. The prepared olive extract is acidic with a pH of 3.5 imparted by the electron withdrawing nature of the phenolic rings. In acidic media, epoxy groups acquire a proton which initiates a S_{N}2 nucleophilic attack by the hydroxyl on the phenolic species. The dissociation of a proton and the subsequent dehydration step culminate in the epoxide reduced to a conjugated double bond while the polyphenol diol is oxidised to a quinone. Similar S_{N}2 and dehydration reactions result in the reduction of both hydroxyl groups and carbonyl groups as per the mechanism proposed in FIG. 7 which illustrates proposed reaction mechanisms involved in the reduction of (a) epoxy groups, (b) hydroxyl groups, and (c) carbonyl groups by olive polyphenolic extract. Without wishing to be bound by theory, the inventors are of the view that polyphenols attach to GO sheets through oxidative coupling and polymerise to allow for cross-linking.

### Phase and Rheological Behaviour of Polyphenol-GO Suspensions

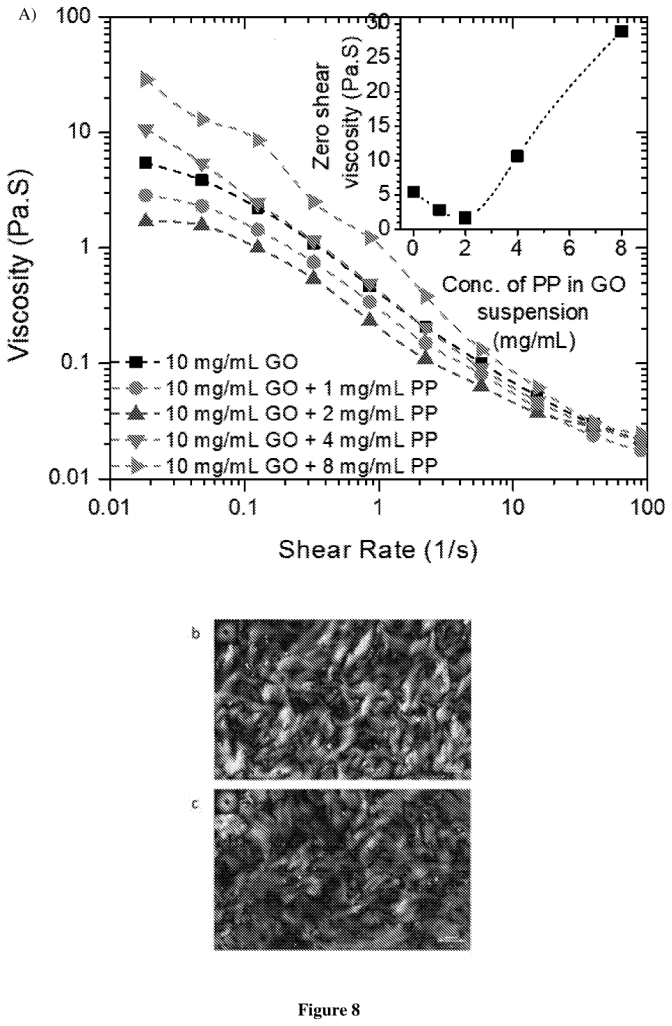

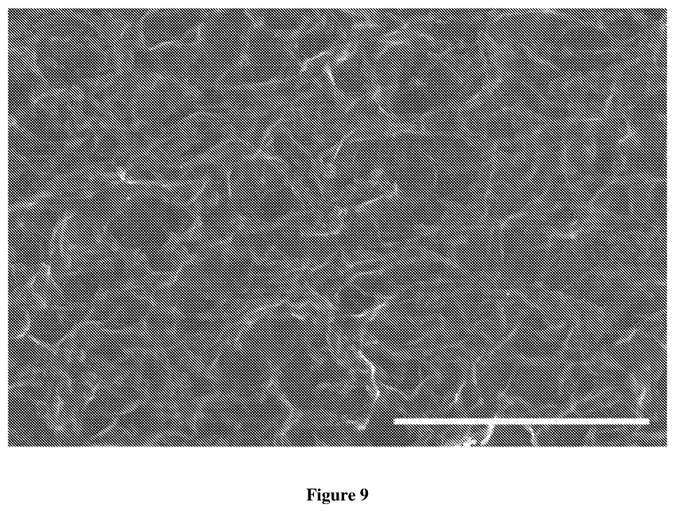

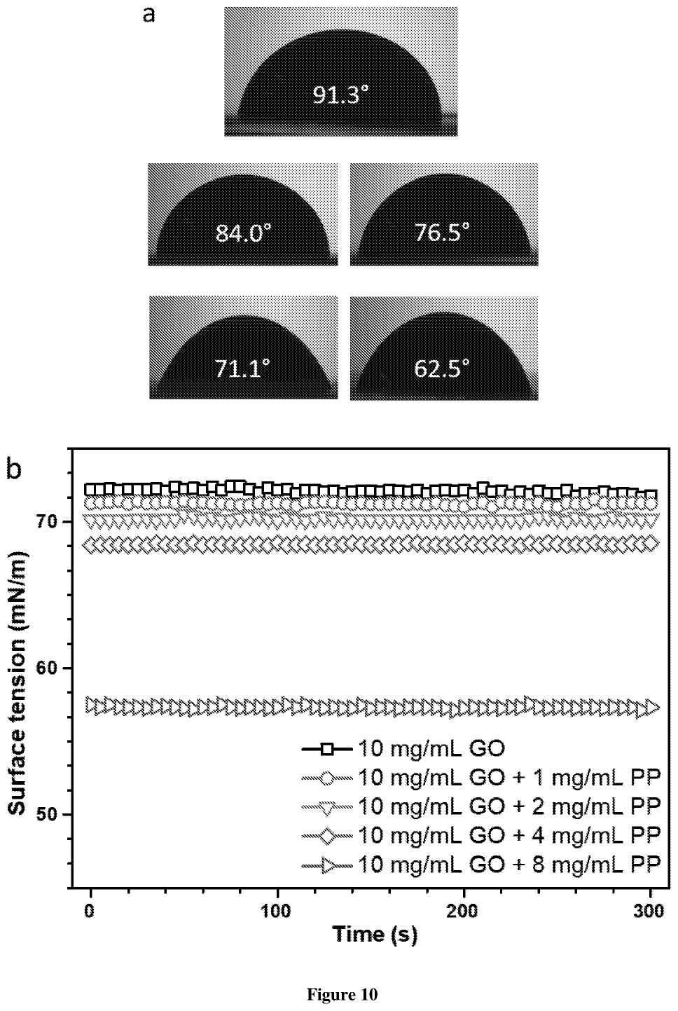

FIG. 8 shows flow properties and phase behaviour of GO and ZERS dispersions. (a) steady-state shear measurement and zero-shear viscosity (inset), pseudocolor polarized light micrographs of (b) GO and (c) ZERS (containing 10 mg/mL GO and 1 mg/ml polyphenol) dispersions. Both GO and ZERS exhibit shear-thinning behaviour typical of clay or polymeric suspensions where applied shear induces molecular ordering of anisotropic colloidal particles. It is evident from the zero-shear viscosity plot (FIG. 8a inset) that in the absence of electrostatic repulsions as a result of the attachment of the polyphenolic species molecular interactions between the GO sheets decrease resulting in lower viscosity for fluid at rest. At high polyphenol concentrations, the increase in volume fraction of the solids gives rise to increase in zero-shear viscosity. This mechanism of lowering the viscosity of structural fluids such as those composed from GO helps in uniform and homogeneous coating over PVDF membrane supports (FIG. 9), resulting in high permeance and high selectivity of GO-based membranes. Polyphenols also have an associated effect in reducing the surface tension of the fluids (FIG. 10). FIG. 9 shows the top surface SEM micrograph of PVDF supported ZERS membrane where the scale bar is 10 microns. FIG. 10 illustrates the effect of polyphenol (PP) concentration on wettability of a 10 mg/mL GO suspension on the MDI PVDF support. (a) Contact angle measurement of the suspension droplet by varying the PP concentration where (i) GO, (ii) GO with 1 mg/mL PP, (iii) GO with 2 mg/mL PP, (iv) GO with 4 mg/mL PP, and (v) GO with 8 mg/mL PP depict a trend of decreasing contact angle with increasing polyphenol content. (b) Surface tension of GO-polyphenol suspension wherein an increase in the polyphenol content is linked to a decrease in surface tension of the suspension.

With lower surface tension and lower viscosity, ZERS exhibits ideal properties of printable fluids. The inventors note that the ZERS fluid (with reduced viscosity and surface tension) still exhibits liquid crystalline behaviour by maintaining structural integrity of the LC domains. FIGS. 8a and b show the polarized light micrograph depicting long-range molecular ordering in an isotropic LC phase with and without the presence of polyphenols, respectively. The presence of LC phase is vital in overall performance of the nanofiltration membranes.

### Permeance and Selectivity Performance of the Polyphenol-GO Composite Membrane

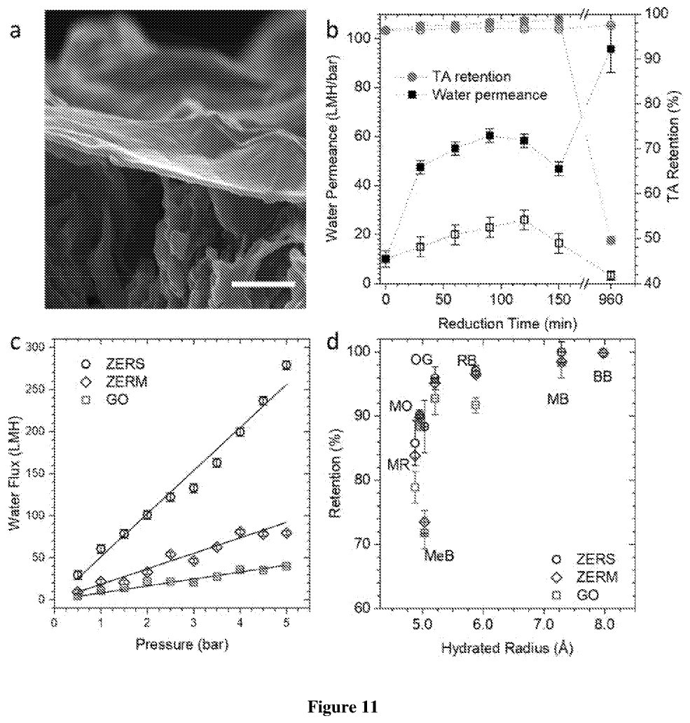

FIG. 11 shows results of the permeance and retention behaviour of GO, ZERS and ZERM membranes. (a) Cross sectional SEM micrograph of PVDF supported ZERS membrane with thickness of approximately 34 nm (scale bar is 400 nm). (b) Water permeance (lower two trend lines) and TA retention (upper two trend lines) of ZERS (filled bullets) and ZERM (empty bullets) membranes with optimal perm-selective properties observed at 90 mins of reduction for ZERS and 120 mins for ZERM. (c) Water flux versus applied transmembrane pressure for optimal ZERS (circle), optimal ZERM (diamond), and GO (square). (d) Retention performance as a function of hydrated radius for probe molecules with different charges and sizes for optimal ZERS (circle), optimal ZERM (diamond), and GO (square). The symbols with a horizontal dash (e) represent negatively charged probes, the symbols with an internal cross (@) represent positively charged probes, and empty symbols (O) represent neutrally charged probes.

Three classes of membranes: GO, polyphenol reduced GO suspension (ZERS) and polyphenol reduced GO membrane (ZERM) (representative cross-sectional SEM image shown in FIG. 11a) were fabricated to understand the role of polyphenols in enhancing membrane performance. The stable water permeance and rejection of Tannic Acid (MW—1701.2 Da) of polyphenol-GO membranes at various stages of reaction conditions were studied in a dead-end filtration setup (FIG. 11b) and indicate that the production of an optimal membrane is reliant on both the method of polyphenol addition and the reduction time. There is a clear trade-off between improved retention and loss in permeance at reduction conditions above optimal; while permeance drops significantly for both ZERS and ZERM membranes there is only a minor improvement in retention. However, following 960 min (16 h) of reduction, there is a significant decline observed in the TA retention performance accompanied with a sharp rise in the water permeance of the ZERS membrane. An unmodified GO membrane (plotted at 0 min of reduction) is observed to have a stable water permeance of 10±3.4 L·m⁻²·h⁻¹·bar⁻¹ and a TA retention of 96.4±0.5%. The ZERM membranes, where the olive reduction occurred post-membrane fabrication, showed improved water permeance and selectivity for TA with an optimal reduction condition occurring at 120 min of polyphenol reduction where water permeance measured 25.9±4.1 L·m⁻²·h⁻¹·bar⁻¹ and had an associated TA retention of 96.7±0.3%. Comparatively, ZERS membranes, fabricated from an olive-extract reduced GO suspension, exhibited much improved water permeances at all stages of reduction. The optimal condition for a ZERS membrane, with an approximate thickness of 34 nm (FIG. 11a), occurs following 90 min of reduction at 70° C. with a resultant water permeance of 60.4±2.8 L·m⁻²·h⁻¹·bar⁻¹ with an associated TA retention of 98.2±0.8%. This value is about an order of magnitude higher than that of currently commercialised nanofiltration membranes (5.7-9.1 L·m⁻²·h⁻¹·bar⁻¹). A comparison of the water flux for the optimised polyphenol-GO membranes with GO is shown in FIG. 11c.

Molecular selectivity is a critical parameter for characterising the performance of a nanofiltration membrane. The mechanism of retention in nanofiltration membranes is an amalgamation of size sieving, electrostatic repulsion, and adsorption effects. The ZERS membranes showed high retention (>90%) for solutes with a hydrated radius above 5.0 Å compared to GO where the same retention is observed for solutes larger than 5.2 Å, as shown in FIG. 11d.

FIG. 12 shows feed, permeate, and retentate stream retention details for (a) ZERS and (b) ZERM retention of TA as a function of reduction time in olive extract where 0 min of reduction refers to as prepared unmodified GO membranes. Feed, permeate, and retentate stream retention details for (c) ZERS, (d) ZERM, and (c) GO retention details of dye probes.

An analysis of the feed, retentate and permeate concentrations (FIG. 12) demonstrates that, for all probes tested, the retentate stream concentrates over the course of the filtration. Concurrently, the adsorption of TA falls from 60.2% in GO membranes to 20.4% for the ZERS membranes. Together, retentate stream concentration and low adsorption are indicative of size sieving and electrostatic effects dominate exclusion over adsorption effects. Of note, the retention for positively and neutrally charged probes is lower for GO membranes compared to both ZERS and ZERM. During the reduction process, the removal of the oxygen functional groups which are ionisable in aqueous media, would naturally decrease the membrane surface charge. If the dominate retention mechanism was electrostatic repulsion, it may be anticipated that the GO membrane have higher retention for negatively charged probes. That the results show the antithesis of this, it can be suggested that size exclusion is the key mechanism by which the various probes are impeded from permeating. Therefore, it is reasonable to conclude that the nanochannels in ZERS membranes are narrower than in GO membranes.

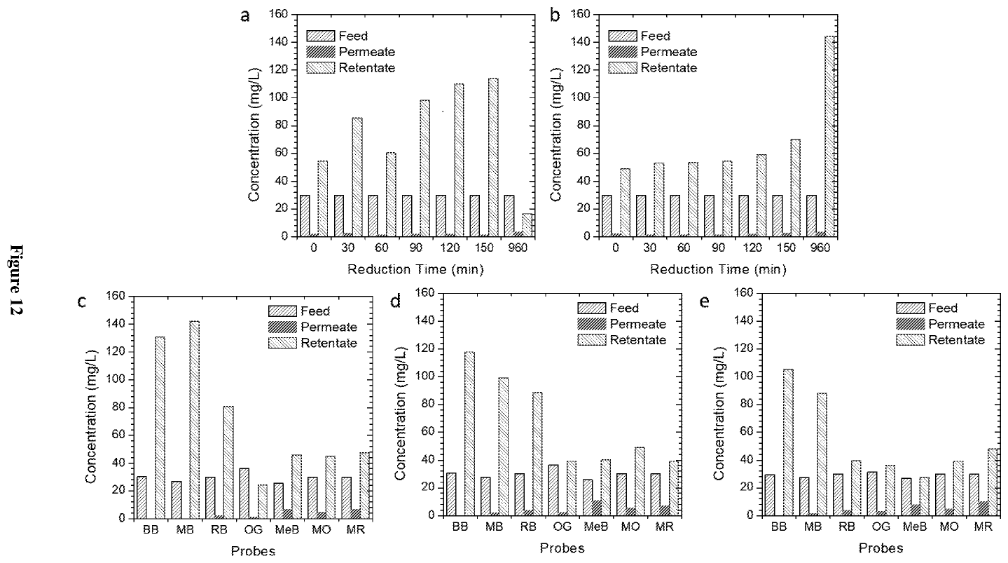

The effect of reduction on the interlayer spacing of the GO structure of ZERS membranes was confirmed by XRD examinations (FIG. 13). FIG. 13 shows XRD peaks of (a) ZERS in the dry state and (b) ZERS membranes in the wet state and (c) the interlayer distance variance with increasing reduction time for ZERS in the dry state (squares) and the wet state (circles). The XRD pattern of a GO membrane presents diffraction peaks at a 2θ of 12.1°, indicating the interlayer space between GO sheets is 7.3 Å. For ZERS membranes, with an increase in the reduction time, this peak shifts to smaller angles (2θ of 10.7° after 90 min) representing an expansion of the interlayer galleries to 8.2 Å. These results indicate that the ZERS-GO structure is becoming less compact despite the removal of the oxygen functional groups that typically act as spacers in GO—the enlarged interlayer galleries indicate the presence of intercalated polyphenol molecules. This confirmation of intercalated polyphenols provides further evidence of the occurrence of covalently grafted polyphenols on the rGO sheets, cross-linking, or π-π interactions between the polyphenols and the rGO. Indeed, following wetting in water, an unmodified GO film expands to an interlayer spacing distance of 11.9 Å. In comparison, in the optimally reduced ZERS film, this phenomenon is much less pronounced where the nanochannel size swells to 10.1 Å, this is schematically depicted in FIG. 14.

FIG. 14 is a schematic representation of the nanochannels of (a) a dry GO membrane with interlayer spacing of 7.2 Å, (b) a dry GO membrane with an interlayer spacing of 8.1 Å, (c) a wet GO membrane with an expanded interlayer of 11.8 Å wherein water molecules cluster around the hydrophilic domains and have slow transport through the membrane, and (d) a polyphenol reduced GO membrane with a 10.1 Å interlayer distance with low friction flow and fast water transport.

The increase in interlayer gallery spacing in ZERS is ˜ 24%, compared to 63% for GO membranes demonstrating the reduced swelling characteristics of ZERS-GO membranes, and the lower interlayer distance of ZERS-GO membranes are consistent with the increased molecular retention characteristics shown in FIG. 11d. This reduced degree of swelling evidence an improvement in the stability of the film in aqueous environments by virtue of polyphenolic treatment.

The fundamental understanding of water permeation through a graphene oxide membrane has generally been based on slip flow theory which describes the transport of water as reliant on the low friction interactions between water molecules and the hydrophobic, graphitic regions a nanochannel. The presence of a large proportion of oxidised groups in the GO nanochannel introduces hydrogen bonding and van der Waals forces that result in water molecules clustering in the hydrophilic regions. These clustered water molecules have lower transport mobility and when paired with the inherent tortuosity of the GO nanostructure, there is a vastly increased friction towards water flow. The increase in sp² domains following the removal of oxygen functional groups could be responsible for the improved water permeance observed by both ZERS and ZERM. These mechanisms are shown schematically in FIG. 14. However, there exists a broad discrepancy in the optimal water permeance attained through both reduction methods. One possibility is appearance of the recovered sp² hybridised domains are poorly distributed across the ZERM membranes. With a predominance of the new graphitic regions occurring at the top surface of the membrane, there remain unreduced layers of GO where water clustering increases permeance resistance in the layers below. Thus, there is an increase in the water permeance initially because of the higher transport mobility associated with the removal of oxygen functional groups. In the post-optimal phase, following 120 min of reduction in ZERM membranes, the GO membrane surface and the nanochannel inlets become increasingly hydrophobic. Decreased water permeability has been observed in laminar graphene membranes following reduction. This has been attributed to the increasing hydrophobicity of preventing the entry of water molecules into the channel spacing. Furthermore, there have been several reports of increased resistance to water transport through tight graphitic nanochannels with sizes less than 0.6 nm. With regards to the ZERS membranes, reduction followed by fabrication allows for a more uniform distribution of evenly reduced GO sheets which could explain the higher permeance of ZERS compared to ZERM. With the results presented in FIG. 11, there appears to be an optimum reduction condition at which there is a balance between these channel effects. This occurs when a membrane is fabricated with a GO suspension with a C:O ratio of 2.34:1, as seen by the XPS analysis which occurs following 90 minutes of olive extract reaction at 70° C.

### Stability of Ultra-Thin Polyphenol-Graphene Oxide Composite Membranes

To approach the upper limit on membrane permeance set by the single-atom thick graphene selective layer, research on laminar graphene oxide membranes have attempted to reduce the film thickness. The efficient transport of water through GO membranes is limited by the tortuous nature of the interlayer spaces that elongates path length. Highly tortuous nanochannels are derived from the high aspect ratio of GO nanosheets with lateral lengths up to several micron. The impact of the tortuous nature of GO laminar structures is further exacerbated by increasing membrane thickness. A 100 nm GO membrane consisting of GO nanosheets with a 5 μm lateral dimension have path lengths up to 200 μm. The path length is halved for a 50 nm GO membrane. By reducing membrane thickness from 200 nm to 100 nm, studies have demonstrated that permeance improves from 37 to 98 L·m⁻²·h⁻¹·bar⁻¹; however, there is an associated drop in dye retention 99.4% to 72.1%. 25 This is an illustration of the effect of instability of thin-film GO membranes.

This instability is bought about by the propensity of GO laminar membranes to swell unrestricted in water. GO laminar membranes have been reported to exhibit an increase in GO interlayer distance to ˜40 nm following 48 hours of soaking in water.

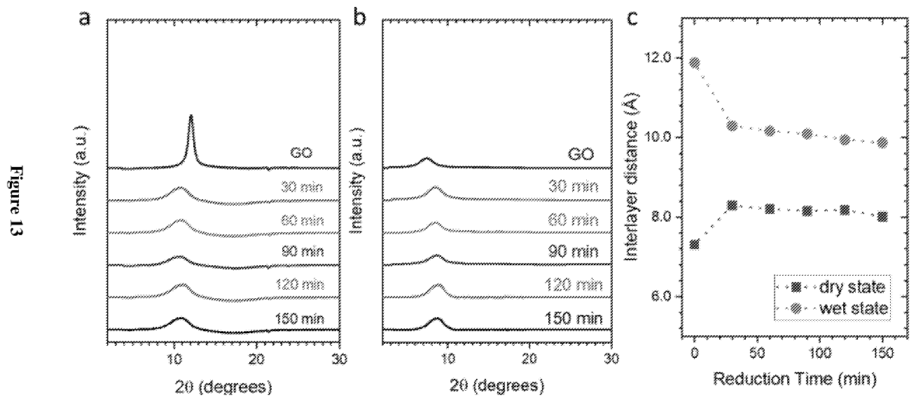

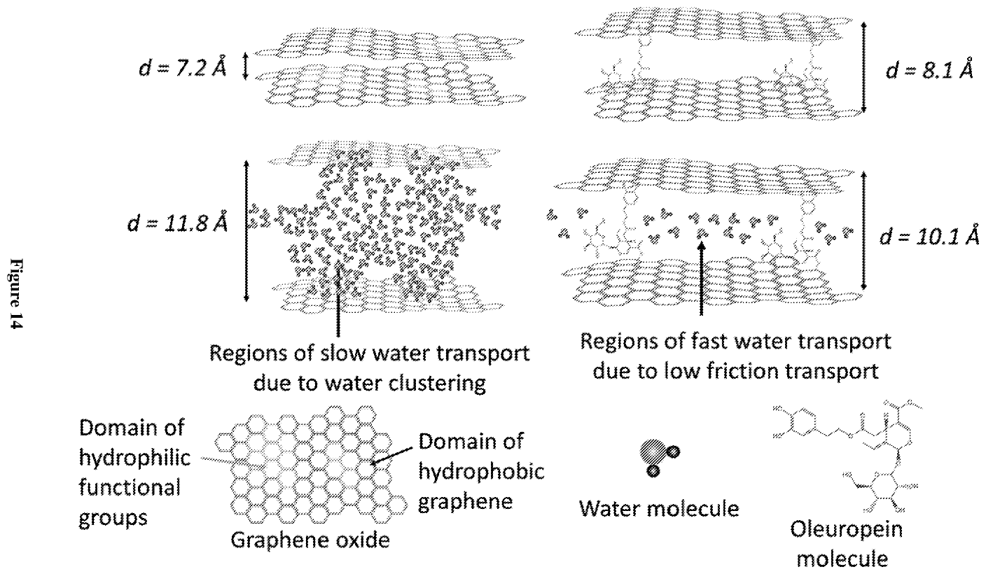

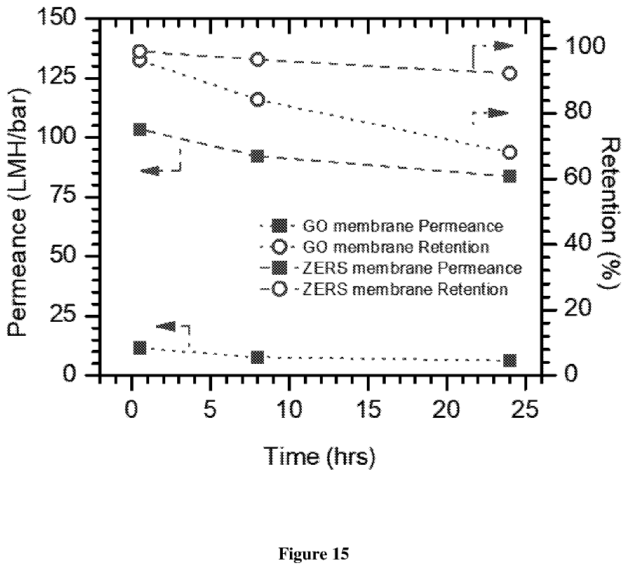

To demonstrate the long-term efficiency and stability of the ZERS membranes in comparison to unreduced GO membranes, both were characterised by crossflow filtration as seen in FIG. 15 (which shows long-term crossflow characterisation of optimal ZERS (70° C.—90 min) and unmodified GO membrane).

The ZERS membranes exhibited notable stability while maintaining excellent rejection (˜92.1% after 24 h) and stable permeance under the stresses imposed by a crossflow rate of 250 mL/min for over the course of 24 h. In comparison, the rejection of TA by the GO membrane fell below 90% in under 10 hours, whilst the permeances were over an order of magnitude lower. These tests illustrate that the ultrathin ZERS membranes are able to achieve simultaneously higher permeance (83.8 L·m⁻²·h⁻¹·bar⁻¹ for ZERS v. 6.4 L·m⁻²·h⁻¹·bar⁻¹ for GO after 24 h) and higher rejection as compared to GO membranes in long-term crossflow studies.

### DISCUSSION

The phenolic compounds present in olive extract react with the functional groups of the GO sheets and allowed facile control of the degree of reduction and simultaneous cross-linking. By manipulating the chemistry of the polyphenols with GO it is possible to ensure the stability of ultrathin (thickness ˜30 nm) GO membranes in aqueous environments. Furthermore, through careful tuning of the proportion of oxygenated functional groups present in the GO nanochannels, high friction, water clustering domains were removed while simultaneously preventing excessive narrowing of the GO channel size thought to be responsible for reduced water transport in highly reduced GO laminar structures. This was further emphasised through long-term filtration tests wherein the optimally reduced polyphenol-GO composite membranes demonstrated permeances of 83.8 L·m⁻²·h⁻¹·bar⁻¹ and a tannic acid rejection of 92.1% after 24 h. Additionally, the presence of the oxidised polyphenols ensures colloidal stability of liquid crystalline GO dispersions with enhanced film formability via decrease of viscosity and surface tension while maintaining processability in aqueous solvents.

### Example 2

This example reports the fabrication of a phenol-GO membrane from a GO reduced using grape polyphenol extract (GPP). GO-GPP membranes were rod coated (rod size 2) using a 10 g/L GO suspension and containing GPP in concentrations ranging from 1 to 8 mg/mL.

The water permeance behaviour with changing concentration of reductant reflects the same behaviour as ZERS and ZERM membranes with an optimal amount of polyphenol additive (occurring at 6 mg/mL GPP) yielding an improved water permeance of 60.2 L·m⁻²·h⁻¹·bar⁻¹ and a MB retention of 99.0%. Further similarities to ZERS occur at high concentration of GPP added wherein a drop in both water permeance and MB retention are observed.

The expected non-Newtonian shear-thinning behaviour was observed for all GO-GPP dispersion where the pseudoplastic response to an increased shear rate is decreasing viscosity. Unusually, the zero-shear viscosity decreases initially until more than 2 mg/mL GPP is added to the GO dispersion at which point there is a subsequent increase. This decrease in viscosity occurs while maintaining the discotic nematic colloidal phase seen for a 10 mg/mL GO dispersion in a 10 mg/mL GO dispersion containing 1 mg/mL GPP. This indicates that the effect of using polyphenol as an additive extends beyond its ability to reduce and stabilise thin-film GO membranes into acting as a viscosity modifier within the GO dispersion to allow for the fabrication of films at low shear rates.

### Example 3

This example reports the fabrication of a phenol-GO membrane from a GO reduced using tannic acid (TA) with a C:O ratio within the range of 2.1 to 5.

10 to 40 mg of tannic acid powder (sigma Aldrich) was added to 10 mL of a 10 g/L GO suspension and then sheared at 3000 rpm for 5 minutes resulting in a GO-TA composite with 1-4 mg/mL polyphenol content (a range of 10:1 to 2.5:1 GO to polyphenol ratios). This suspension was then temperature treated at 70° C. for 90 minutes. After cooling completely, the polyphenol-GO suspension was then coated on to an MDI PVDF support using a number 2 mayer rod coater.

A membrane was formed according to the procedure generally described in Example 1. The resulting membrane had a permeance of 41.4 L·m⁻²·h⁻¹·bar⁻¹ and a MB retention of 98.7%.

### Example 4

This example reports the fabrication of a phenol-GO hollow fibre membrane from a GO suspension that is reacted with tannic acid with a C:O ratio within the range of 2.1 to 5.

The graphene oxide (GO) utilised in this study was sourced from the Sixth Element Materials Technology Co. Ltd (Changzhou, China). A suspension of GO was mixed with tannic acid in proportion of 1:1.5 GO to tannic acid (TA, 1,701.2 Da, Sigma-Aldrich, Australia), the mixture was then stirred at a temperature of 85° C. for 3 hours.

Polyethersulfone (PES) (Ningbo Jiangbei Yun-tech Environmental Protection Technology, China) Hollow fibre strands (strand diameter=0.6 mm) were used as membrane supports. GO has poor adhesion to the PES support. To improve adhesion, the supports were rinsed in ethanol and treated with tannic acid. The catechol type groups in the tannic acid structure allow for improved adhesion. Treatment in 15 g/L TA for 10 min improved adhesion; however, treatment for 30 minutes and above resulted in a low permeability PES support. The GO-polyphenol inks have improved adhesion to the PES support and thus do not require TA pre-treatment of the support for the development of a stable membrane.

The HF membranes were coated in graphene oxide via pressure-assisted self-assembly, a length of TA treated PES HF (between 20-50 mm long) was placed in the dead-end HF testing apparatus. Solutions of rGO-polyphenol were filtered through the support at 1 bar.

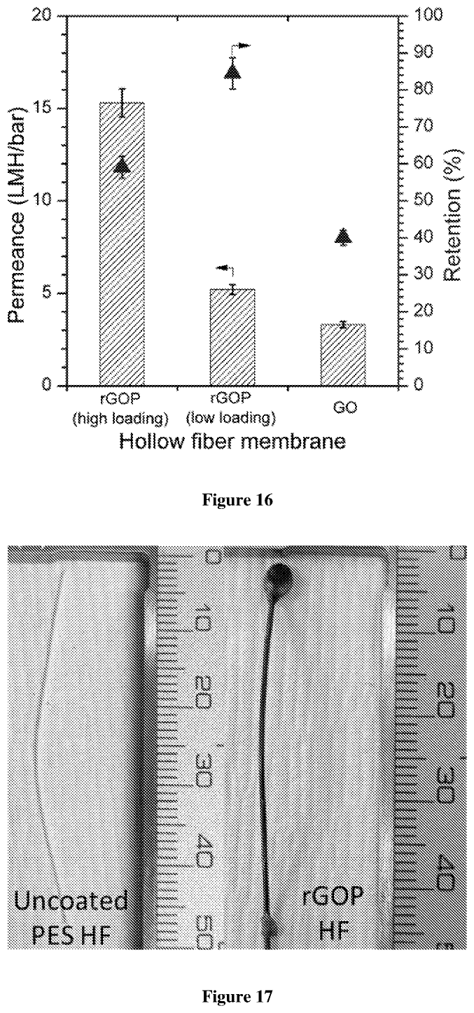

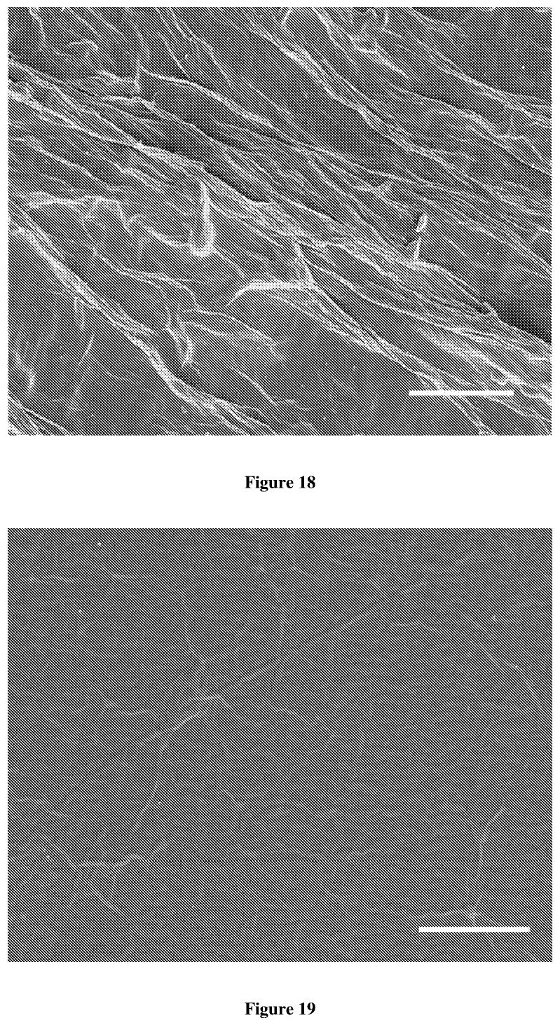

FIGS. 16-19 report the results of the experiment. FIG. 16 is a graph illustrating permeance and TA retention performance of rGO-polyphenol and GO hollow fiber membranes. FIG. 17 provides two photographs showing (i) the uncoated PES hollow fiber support (left) and (ii) the coated rGO-polyphenol hollow fiber nanofiltration membrane (right). The scale is in mm. FIG. 18 and FIG. 19 are scanning electron microscope images of GO coated HF with 100 mg/L and 5 mg/L rGO-polyphenol suspensions respectively. The scale bars represent 10 μm.

Polyphenol reduced graphene oxide results in improved permeance due to the removal of hydrophilic oxygen functional groups that hinder fast water transport. Additionally, membrane stability in aqueous media is improved resulting in membranes with higher retention. Scanning electron microscopy images (FIG. 18 and FIG. 19) demonstrate a continuous and uniform coating on the PES hollow fibre. Coating with a 100 mg/L concentration of rGO results in a surface with large wrinkles (FIG. 18). These wrinkles act has enlarged pathways through the membrane resulting in membranes with higher permeance but lower retention.

### Example 5

This example reports the preparation of polyphenol-holey graphene oxide with a C:O ratio within the range of 2.1 to 5 e.g. for use in low pressure/high permeance membranes.

Holey GO (hGO) was synthesized by a two-stage UV/H₂O₂ photochemical process. A 10 mg/mL GO suspension is mixed with 30% by weight H₂O₂ then exposed to UVA or UVB light (wavelength of 365 nm or 315 nm, respectively) for 5, 15, and 30 min to produces hGO with pores of 10 nm, 30 nm, and 60 nm, respectively. The GO/H₂O₂ suspension was then exposed to UVC irradiation (254 nm) for 17 hours. Holey GOs with different porous structures were achieved by changing the UV wavelength and exposure time in each stage. Before membrane preparation, the residual H₂O₂ was removed by centrifuging the suspension at 10,000 rpm and disposing of the supernatant.

A 10 g/L suspension of holey GO was mixed polyphenol at a mass ratio of 10:3 hGO to polyphenol. The mixture is heated under mild reduction conditions of 70° C. for 90 minutes to obtain reduced holey GO-polyphenol membranes.

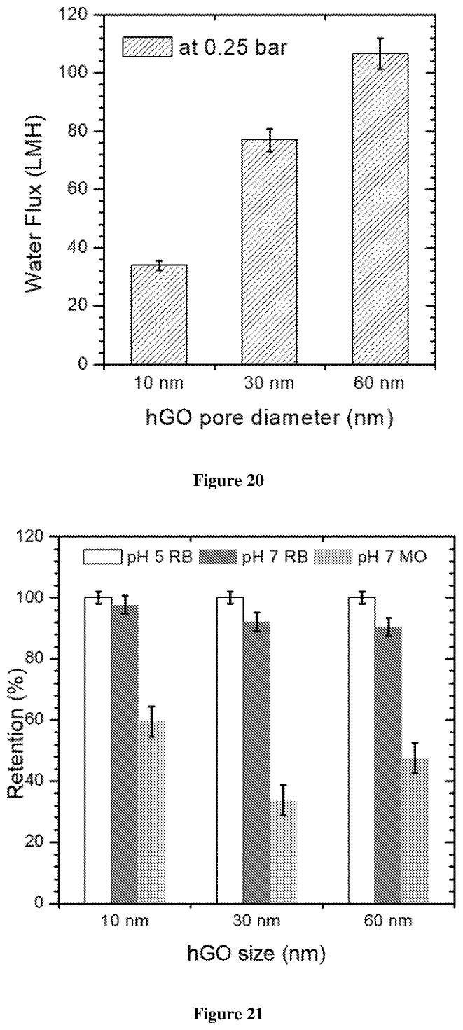

FIG. 20 is a graph showing the water flux of hGO-polyphenol membranes at 0.25 bar.

FIG. 21 is a graph showing retention for rose bengal (MW of 973 Da) and methyl orange (MW of 327 Da).

The holey GO provides shorter water transport pathways through the membrane. When combined with polyphenol which reduces the GO and enhances retention and stability in aqueous media, the result is membranes with ultra-high permeance without loss in retention.

The optimal pore size for holey GO-polyphenol membranes is less than 100 nm and more optimally between 10 and 60 nm. For holey GO-polyphenol membranes with pores diameters of 100 nm and above retention for below ˜1000 Da drops below 90%.

The reduced hGOP membranes with pore diameters between 10 and 60 nm have permeances between 135.5 and 426.8 LMH/bar without sacrificing the molecular weight cut-off of the membranes.

### Example 6

This example reports the preparation of UV reduced rGO-polyphenol membranes with a C:O ratio within the range of 2.1 to 5 for ion separation applications.

GO-polyphenol membranes containing a ratio of 10:6 GO to polyphenol was prepared using rod coating. The membranes were then irradiated with a 254 nm wavelength UVC light source (55 W, Philips, TUV PL-L 55W/4P) for timeframes between 10 and 60 minutes.

UV reduction was done to achieve high degrees of reduction in the GO-polyphenol membranes while the function of the polyphenols is to act as a spacer between adjacent GO sheets preventing the high degree of reduction from resulting in an impermeable graphitic nanochannel. This combination results in a tight GO structure capable of retaining ions.

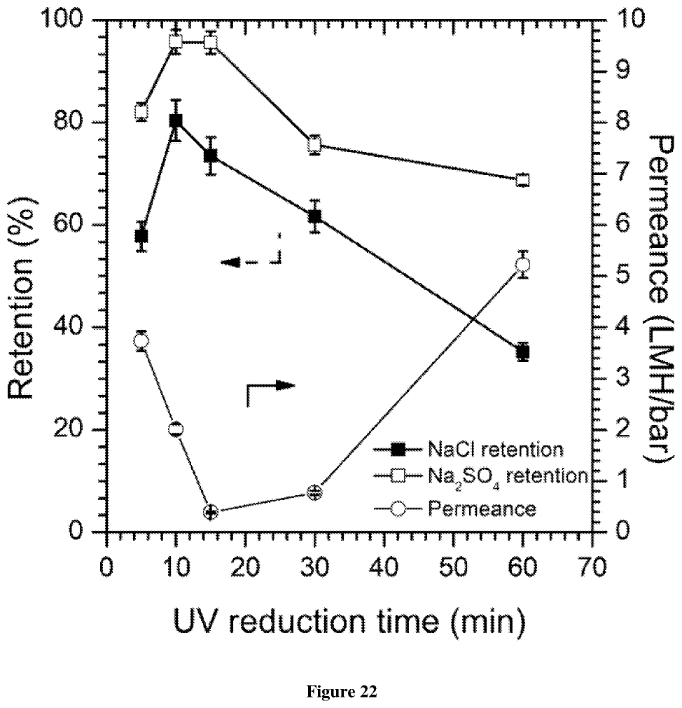

FIG. 22 is a graph showing the water permeance (open circle symbol) of membranes with optimal permeance for ion retention being 0.4 LMH/bar and Retention of 10 mM NaCl (solid square symbol) and Na₂SO₄ (open square symbol).

A UV reduction time of between 10 to 20 minutes was found to be optimal under UVC for optimum retention of both monovalent and divalent salts. Retentions of Na₂SO₄ above 95% and NaCl above 80% can be achieved using UV reduced GO-polyphenol membranes under these conditions.

At UV exposure times of 60 minutes and higher, retention is reduced while permeance increases due to the growing proportion of defects introduced to the GO sheets under UVC exposure.

### Example 7

This example reports the preparation of reduced rGO-polyphenol membranes with a C:O ratio within the range of 2.1 to 5 using select polyphenols for ion separation applications and retention at high ionic concentrations.

The aim of this example is to use low molecular weight polyphenols with an anthracene plane such as caffeic acid, ellagic acid and gallic acid (and molecules with a close to 2D anthracene plane such as quercetin) in combination with GO/rGO to construct thin 2D liquid crystalline membranes for desalination at high salt concentrations.

The polyphenols simultaneously act to partially reduce GO (removing functional groups and increasing the portion of sp² domains) and act as an intercalatant between the rGO lamella. Reduction and pi-conjugation between rGO and polyphenols act to improve membrane stability (minimize swelling in aqueous mediums)

Polyphenols with an anthracene plane (i.e. 2D in structure) influence the rejection of salts by manipulating the vertical (controlling and stabilizing interlayer spacing) and lateral (interlayer gallery space of rGO lamella) to create a unique microstructure that rejects even small alkali ions such as Na⁺. Polyphenols investigated for this application include caffeic acid, gallic acid, quercetin, ellagic acid, coumarin, p-coumaric acid, and luteolin.

A 10 g/L suspension of GO is rapidly mixed with a powder of polyphenol at a weight content in the range of 20-50 wt % polyphenol, but 30 wt % is ideal. At a mild reduction temperature of no more than 80° C., but not lower than 60° C., the suspension is mixed for at least 20 min but no more than 4 hrs to obtain >50% rejection of NaCl.

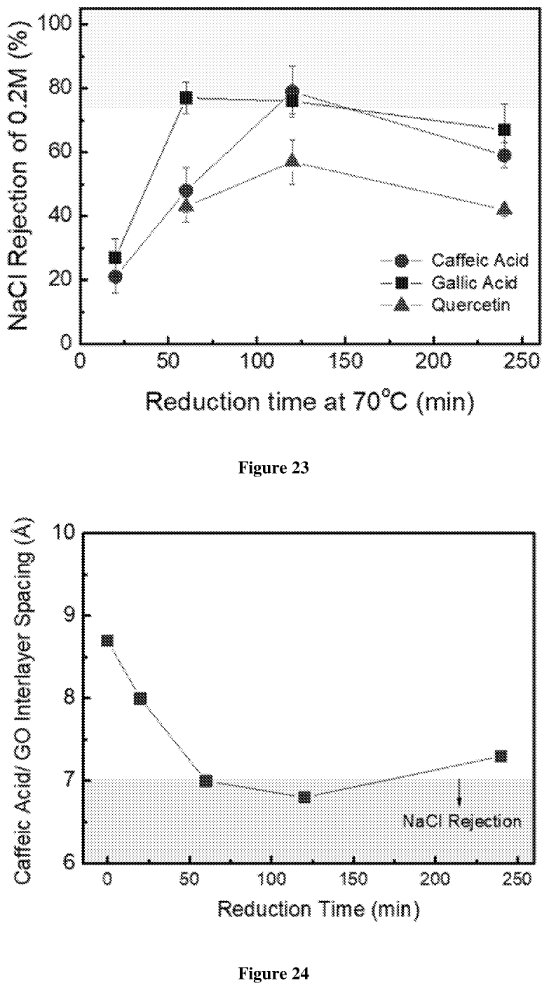

FIG. 23 is a graph showing the retention of rGO-caffeic acid, rGO-gallic acid and rGO-quercetin membranes for 0.2M NaCl.

FIG. 24 is a graph showing interlayer spacing of rGO-caffeic acid indicating optimal reduction times for size exclusion-based retention of NaCl. From the graph it is apparent that the interlayer spacing is between 6.5 and 7.4 Å.

The results indicate that (i) a reduction time of 60-120 min at a temperature of 70° C. provides optimum rejection performance, (ii) very high concentrations of NaCl (0.2M) can be rejected ˜80% by caffeic and gallic acid (anthracene plane), with lower rejection with quercetin (non-anthracene plane, but very close to 2D structure), (iii) rejection performance is closely related to interlayer spacing, suggesting that rejection mechanism is predominantly by size exclusion, (iv) at reduction times >120 mins, rejection performance becomes compromised due to the growing disorder and wrinkling of the GO sheets, and (v) pure water permeance of these membranes is 0.2 LMH/bar.

It will be understood that the invention disclosed and defined in this specification extends to all alternative combinations of two or more of the individual features mentioned or evident from the text or drawings. All of these different combinations constitute various alternative aspects of the invention.

1. A phenolic-graphene oxide composition comprising phenolic-graphene oxide having a carbon to oxygen (C:O) ratio of 2.1 or greater and 5 or less.

2. A liquid crystalline phenolic-graphene oxide composition comprising discotic phenolic-graphene oxide particles having a carbon to oxygen (C:O) ratio of 2.1 or greater and 5 or less.

3. The composition of claim 2, wherein composition has a zero-shear viscosity of 100 Pa·s or less.

4. The composition of claim 2 or 3, wherein the composition has a contact surface angle on a PVDF support surface of less than 90 degrees.

5. The composition of any one of claims 2 to 4, wherein the composition has a phenolic to graphene oxide weight ratio of less than 1.

6. The composition of any one of claims 2 to 5, wherein the concentration of phenolic-graphene oxide particles is at least 5 g/L.

7. The composition of any one of the preceding claims, wherein the phenolic-graphene oxide comprises graphene oxide with a phenol bonded thereto.

8. The composition of any one of the preceding claims, wherein the C:O ratio is 2.15 or greater and/or is 4 or less.

9. A method of forming a liquid crystalline phenolic-graphene oxide composition comprising:
providing a liquid phase reaction mixture comprising a phenolic compound and discotic graphene oxide particles; and
facilitating a reaction between the phenolic compound and the discotic graphene oxide particles for a time sufficient to form a composition comprising discotic phenolic-graphene oxide particles having a carbon to oxygen (C:O) ratio of greater than 2.1 and less than 5.

10. The method of claim 9, wherein the liquid phase reaction mixture comprises the phenolic compound and the discotic graphene oxide particles in a weight ratio of less than 1.

11. The method of claim 9 or 10, wherein the liquid phase reaction mixture comprises the discotic graphene oxide particles in an amount of at least 5 g/L.

12. The method of any one of claims 9 to 11, wherein the step of facilitating the reaction comprises heating the liquid phase reaction mixture to a temperature of 80° C. or less and/or subjecting the liquid phase reaction mixture to UV light.

13. The method of any one of claims 9 to 12, wherein the time is from about 0.5 hours up to about 16 hours.

14. The method of any one of claims 9 to 13, wherein prior to and/or during the step of facilitating the reaction, the method further comprises shear mixing the liquid phase reaction mixture.

15. A phenolic-graphene oxide film comprising a laminar arrangement of phenolic-graphene oxide having a C:O ratio of 2.1 or greater and 5 or less.

16. The film of claim 15, wherein the laminar arrangement comprises a plurality spaced apart layers of phenolic-graphene oxide having an interlayer spacing therebetween graphene oxide sheets with a phenolic compound located within the interlayer spacing.

17. The film of claim 16, wherein the interlayer spacing is from about 7.4 Å or greater when measured in a dry state up to about 12 Å or less when measured in a wet state.

18. The film of claim 16, wherein the interlayer spacing is from about 6.5 up to about 7.4 Å when measured in a dry state.

19. A separation membrane comprising a membrane layer formed from a phenolic-graphene oxide film of any one of claims 15 to 18.

20. The separation membrane of claim 19, wherein the separation membrane comprises a substrate layer with the membrane layer applied thereto, and the membrane layer has a thickness of 100 nm or less.

21. The separation membrane of claim 19 or 20, wherein the membrane has:
(i) a water permeance of 20 L·m⁻²·h⁻¹·bar⁻¹ or greater; or
(ii) a water permeance of 5 L·m⁻²·h⁻¹·bar⁻¹ or less and a retention of at least 90% for molecules with a hydrated radius of 0.33 nm or greater.

22. A method of forming a phenolic-graphene oxide membrane comprising:
solution casting a liquid crystalline phenolic-graphene oxide composition any one of claims 2 to 8 onto a surface to form the phenolic-graphene oxide membrane.

23. The method of claim 22, wherein the step of solution casting further comprises subjecting the liquid crystalline phenolic-graphene oxide composition to shear forces sufficient to shear align the discotic phenolics-graphene oxide particles.

24. A method of forming a phenolic-graphene oxide membrane comprising:
contacting a graphene oxide film or membrane with a phenolic compound, and
facilitating a reaction between the phenolic compound and the graphene oxide for a time sufficient to form a phenol-graphene oxide film or membrane in which the phenolic-graphene oxide has a carbon to oxygen (C:O) ratio of greater than 2.1 and less than 5.

25. Use of a phenolic-graphene oxide film of any one of claims 15 to 18 or a separation membrane of any one of claims 19 to 21 in a membrane separation process.
